(19) United States
(12) Patent Application Publication
(10) Pub. No.: US 2026/0176482 A1
(43) Pub. Date: Jun. 25, 2026

(54) Coating Compositions, Films, And Methods

(71) Applicant: Adept Materials, Inc., Somerville, MA (US)

(72) Inventors: Derek Martin Stein, Providence, RI (US); Ilya Rushkin, Acton, MA (US); Yi-Jie Tsou, Somerville, MA (US); Doycho Karagyozov, Somerville, MA (US); Zachary Usher, Waltham, MA (US)

(21) Appl. No.: 19/537,011

(22) Filed: Feb. 11, 2026

Related U.S. Application Data
(63) Continuation of application No. PCT/US25/10822, filed on Jan. 8, 2025.
(60) Provisional application No. 63/618,680, filed on Jan. 8, 2024.

(51) Int. Cl. C09D 7/65; C09D 7/20; C09D 7/61; C09D 133/06

(52) U.S. Cl. CPC C09D 7/65; C09D 7/20; C09D 7/61; C09D 133/06

(57) ABSTRACT

Liquid coating compositions, films, and methods of applying and manufacturing the liquid coating compositions are provided. The liquid coating compositions can include water, where the water can be present in the liquid compositions in an amount from about 30 wt. % to about 70 wt. %. The liquid coating compositions can also include a silica gel that reversibly adsorbs and desorbs water. The silica gel can be present in the liquid coating compositions in an amount from about 5 wt. % to about 30 wt. % and can have an open pore volume from about 0.2 mL/g to about 1.0 mL/g. The liquid coating compositions can also include a polymeric binder, where the polymeric binder can be present in the liquid coating compositions in an amount from about 4 wt. % to about 50 wt. %. Method for controlling moisture and humidity in a building or part of a building using the liquid coating compositions are also provided.

### CROSS-REFERENCE TO RELATED APPLICATION

This application claims priority to U.S. Provisional Application No. 63/618,680 filed Jan. 8, 2024, and entitled “DESICCANT PAINT FORMULATIONS AND METHODS,” the entire contents of which are hereby expressly incorporated by reference herein.

### TECHNICAL FIELD

The present disclosure is directed to coating compositions, films made therefrom, and methods for controlling moisture and humidity in a building or part of a building using the same.

### BACKGROUND

Buildings account for nearly 40% of primary energy consumption in the United States and more than one-third of greenhouse gas emissions. A large fraction of building energy is directed to maintaining comfortable and healthy interior conditions through heating, cooling, and humidity control. Temperature control is desirable because the range of human comfort extends only about 8.5° C., according to the ASHRAE 55 standard. Controlling moisture and humidity is desirable for multiple reasons, including comfort, indoor air quality, energy efficiency, and durability. Excessive moisture poses a significant threat to buildings, as it can cause a range of structural and environmental problems. Moisture accumulation can lead to decay, rot, and corrosion that compromise the integrity of building materials. It also creates an ideal breeding ground for mold and mildew, raising indoor air quality concerns and potential health hazards. Moisture-related problems can also degrade energy efficiency (by decreasing the R-value of insulation, for example) and increase maintenance costs. As such, addressing the challenges associated with moisture is needed for preserving the longevity, safety, and habitability of buildings.

Bathrooms are an area of concern because hot showers produce large quantities of water vapor that can condense on surfaces and make its way by diffusion into building materials like gypsum wallboard and insulation materials in wall and ceiling cavities. Closets are another area of concern because a large quantity of water vapor can get trapped inside a closet when it is closed during warm, humid weather, and when the temperature falls, the humidity inside the closet rises and the water can condense, leading to damage to the closet or its contents. Other parts of a building that face challenges related to condensation, dampness, or humidity include basements; wet areas like kitchens; gyms and exercise areas; conference rooms; unconditioned rooms; storage areas; attics; and the exterior walls of a building, especially behind paintings, mirrors, and other objects that can trap moisture near the wall. Materials that regulate the interior humidity and temperature without consuming primary energy or causing incremental greenhouse gas emissions are desirable for increasing the energy efficiency and sustainability of buildings. Finally, the aesthetic quality of exposed building materials is also desirable to the owners, managers, and occupants of buildings.

Accordingly, there remains a need for improved coating compositions to inhibit condensation and regulate the humidity and temperature inside a building or a part of a building.

### SUMMARY

In one aspect, an exemplary liquid coating composition is provided. The liquid coating composition includes water, present in the liquid composition in an amount from about 30 wt. % to about 70 wt. %. The liquid coating composition also includes a silica gel that reversibly adsorbs and desorbs water, where the silica gel is present in the liquid coating composition in an amount from about 5 wt. % to about 30 wt. % and has an open pore volume that is be from about 0.2 mL/g to about 1.0 mL/g. The liquid coating composition also includes a polymeric binder, where the polymeric binder is present in the liquid coating composition in an amount from about 4 wt. % to about 50 wt. %.

In some aspects, the water can be present in the liquid coating composition in an amount from about 35 wt. % to about 65 wt. % or about 40 wt. % to about 60 wt. %.

In some aspects, the silica gel can include a plurality of particles having an average particle size from about 1 micrometer to about 20 micrometers, from about 3 micrometers to about 15 micrometers, or from about 5 micrometers to about 10 micrometers.

In some aspects, the polymeric binder can include a plurality of particles having an average particle size from about 200 nm to about 350 nm.

In some aspects, the silica gel can be present in the liquid coating composition in an amount from about 15 wt. % to about 30 wt. % or from about 7 wt. % to about 30 wt. %.

In some aspects, the liquid coating composition can have a Stormer viscosity in the range from about 80 KU to about 120 KU or from about 70 KU to about 130 KU.

In some aspects, the silica gel can include a plurality of particles, where each particle can have a specific surface area from about 500 m2/g to about 900 m2/g.

In some aspects, the polymeric binder can include one or more polymeric latexes which can include pure acrylic, vinyl acrylic, styrene acrylic, or any combination thereof.

In some aspects, the liquid coating composition can further include one or more co-solvents which can include propylene glycol, ethylene glycol, isopropanol, ethanol, propylene carbonate, or 2-amino-2-methyl-1-propanol. In some aspects, the one or more co-solvents can be present in the liquid coating composition in an amount from about 1 wt. % to about 10 wt. % or from about 0.1 wt. % to about 20 wt. %.

In some aspects, the liquid coating composition can further include dispersed particles of one or more organic or inorganic pigments or a mixture of different organic and/or inorganic pigments.

In some aspects, the one or more inorganic pigments can include titanium dioxide, iron oxide, zinc oxide, cobalt blue, cobalt violet, cobalt green, manganese violet, purple of Cassius, Prussian blue, Persian blue, malachite, Green earth, titanium yellow, zinc yellow, or any combination thereof.

In some aspects, the one or more organic pigments can include monoazo, disazo, laked azo, β-naphthol, naphthol AS, benzimidazolone, disazo condensation, azo metal complex pigments, polycyclic pigments, or any combination thereof.

In some aspects, the polycyclic pigments can include phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, triarylcarbonium, diketopyrrolopyrrole pigments, carbon black pigments, or any combination thereof.

In some aspects, the carbon black pigments can include gas black pigments, furnace black pigments, monoazo pigments, disazo pigments, or any combination thereof. In some aspects, a Colour Index of the carbon black pigments can be Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34, Pigment Brown 41, or any combinations thereof.

In some aspects, a Colour Index of the isoindolinone pigments or the isoindoline pigments can be Pigment Yellow 139 Pigment Yellow 173, or any combination thereof.

In some aspects, a Colour Index of the phthalocyanine pigments can be Pigment Blue 15, Pigment Blue 15:1, Pigment Blue 15:2, Pigment Blue 15:3, Pigment Blue 15:4, Pigment Blue 15:6, Pigment Blue 16, Pigment Green 7, Pigment Green 36, or any combination thereof.

In some aspects, a Colour Index of the anthanthrone, anthraquinone, quinacridone, dioxazine, indanthrone, perylene, perinone, or thioindigo pigments can be Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23, Pigment Orange 43, or any combination thereof.

In some aspects, a Colour Index of the triarylcarbonium pigments can be Pigment Red 169, Pigment Blue 56, Pigment Blue 61, or any combination thereof.

In some aspects, a Colour Index of the diketopyrrolopyrrole pigments can be Pigment Red 254, Pigment Red 255, Pigment Red 264, Pigment Red 270, Pigment Red 272, Pigment Orange 71, Pigment Orange 73, Pigment Orange 81, or any combination thereof.

In some aspects, a Colour Index of the β-naphthol pigments or the naphthol AS pigments can be Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38, Pigment Brown 1, or any combinations thereof.

In some aspects, a Colour Index of the laked azo metal complex pigments or the azo metal complex pigments can be Pigment Red 48:2, Pigment Red 48:3, Pigment Red 48:4, Pigment Red 57:1, Pigment Red 257, Pigment Orange 68, Pigment Orange 70, or any combination thereof.

In some aspects, a Colour Index of the benzimidazoline pigments can be Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, Pigment Brown 25, or any combination thereof.

In some aspects, a particle size of the dispersed particles of one or more organic or inorganic pigments or a mixture of different organic and/or inorganic pigments can be about 10 micrometers or less.

In some aspects, the liquid coating composition can further include one or more anionic or nonionic surface tension-controlling additives. In some aspects, the one or more surface tension-controlling additives can include alkali metal, amine salts of alkyl, ammonium salts of alkyl, aryl, alkaryl, aralkyl sulfates, sulfonates, phosphates, phosphonates, ethoxylated fatty acids, esters, alcohols, amines, amides, phenols, sulfur-containing compounds, ether units, polyether units, propoxyl, or any combination thereof. In some aspects, the one or more surface tension-controlling additives can be present in the liquid coating composition in an amount of about 1 wt. % or less.

In some aspects, the liquid coating composition can further include one or more dispersants. In some aspects, the one or more dispersants can include potassium tripolyphosphate, one or more salts of carboxylic acid, or any combination thereof. In some aspects, the one or more dispersants can be present in the liquid coating composition in an amount from about 0.01 wt. % to about 5 wt. % or from about 0.1 wt. % to about 2 wt. %.

In some aspects, the liquid coating composition can further include one or more rheology modifiers. In some aspects, the one or more rheology modifiers can include one or more inorganic rheology modifiers. In some aspects, the one or more inorganic rheology modifiers can include modified clays, unmodified clays, or any combination thereof. In some aspects, the one or more rheology modifiers can include one or more organic rheology modifiers including cellulosic polymers, acrylic polymers, urethane polymers, or any combination thereof. In some aspects, the one or more rheology modifiers can be present in the liquid coating composition in an amount from about 0.01 wt. % to about 5 wt. % or from about 0.02 wt. % to about 2 wt. %.

In some aspects, the liquid coating composition can further include one or more foam-controlling additives or defoamers. In some aspects, the one or more foam-controlling additives or defoamers can be present in the liquid coating composition in an amount of 0.5 wt. % or less.

In some aspects, the liquid coating composition can further include one or more coalescence promoters. In some aspects, the one or more coalescence promoters can include Polyethylene Glycol, Polypropylene Glycol, or esters or ethers of di-, tri-, or poly-ethylene or propylene glycols, or any combination thereof. In some aspects, the one or more coalescence promoters can be present in the liquid coating composition in an amount of about 2 wt. % or less.

In some aspects, the liquid coating composition can further include one or more biocides. In some aspects, the one or more biocides can include Methylbenzimidazole-2-yl Carbamate, 3-Iodo-2-propynyl butyl carbamate, 1,2-Benzisothiazolin-3-one (BIT), 2,2-Dibromo-3 nitrilopropi-onamide (DBNPA), or any combination thereof. In some aspects, the one or more biocides can be present in the liquid coating composition in an amount less than about 0.5 wt. %.

In some aspects, the liquid coating composition can further include one or more pH modifiers. In some aspects, the one or more pH modifiers can include inorganic acids, organic acids, inorganic bases, organic bases, or any combination thereof. In some aspects, the inorganic acids can include ammonia, the organic acids can include acetic acid, maleic acid, citric acid, or a combination thereof, the inorganic bases can include sodium hydroxide, potassium hydroxide, ammonium hydroxide, or any combination thereof, and the organic bases can include amines. In some aspects, the one or more pH modifiers can be present in the liquid coating composition in an amount of about 3 wt. % or less.

In some aspects, the liquid coating composition can have a fineness of grind of Hegman 4 or higher. In some aspects, the liquid coating composition can have a shelf life of at least 6 months.

In some aspects, the polymeric binder can be present in the liquid coating composition in an amount from about 5 wt. % to about 35 wt. % or from about 5 wt. % to about 15 wt. %.

In another aspect, an exemplary method for controlling moisture and humidity in a building or part of a building is provided. In some aspects, the method can include applying one or more liquid coating compositions of any one of the preceding claims to at least a portion of one or more interior surfaces of the building or part of the building. In some aspects, the method can also include allowing the one or more liquid coating compositions to dry on at least the portion of one or more interior surfaces of the building until the one or more liquid coating compositions form a solid film with a water content below 20% by weight of the film. In some aspects, allowing the one or more liquid coating compositions to dry can include actively drying the one or more liquid coating compositions.

In some aspects, the silica gel can be present in the film in an amount from about 10 wt. % to about 60 wt. % of the dry weight of the film or from about 15 wt. % to about 50 wt. % of the dry weight of the film.

In some aspects, the polymeric binder can be present in the film in an amount from about 10 wt. % to about 70 wt. % of the dry weight of the film or from about 10 wt. % to about 40 wt. % of the dry weight of the film.

In some aspects, applying the one or more liquid coating compositions can include brushing the one or more liquid coating compositions onto at least a portion of one or more interior surfaces of the building. In some aspects, applying the one or more liquid coating compositions can include spraying the one or more liquid coating compositions onto at least a portion of one or more interior surfaces of the building. In some aspects, applying the one or more liquid coating compositions can include rolling the one or more liquid coating compositions onto at least a portion of one or more interior surfaces of the building.

In some aspects, the at least a portion of one or more interior surfaces can be located in a bathroom of the building.

In some aspects, the film can have a dry coat weight from about 40 g/m2 to about 500 g/m2, or from about 50 g/m2 to about 400 g/m2, or from about 75 g/m2 to about 300 g/m2.

In another aspect, an exemplary method for manufacturing a liquid coating composition is provided. The method includes mixing water, a silica gel, and a polymeric binder to form a mixture. The water is present in the liquid coating composition in an amount from about 30 wt. % to about 70 wt. % and the silica gel is present in the liquid coating composition in an amount from about 5 wt. % to about 30 wt. %. The silica gel has an open pore volume that is be between about 0.2 mL/g to about 1.0 mL/g. The polymeric binder is present in the liquid coating composition in an amount from about 4 wt. % to about 50 wt. %. In some aspects, the polymeric binder can include one or more polymeric latexes, the one or more polymer latexes including pure acrylic, vinyl acrylic, styrene acrylic, or any combination thereof.

In another aspect, another exemplary method for manufacturing a liquid coating composition is provided. The method includes combining water, one or more surfactants, one or more dispersants, and one or more defoamer components in a vessel to form a first mixture, stirring the first mixture, adding one or more rheology modifier components to the mixture, and thoroughly dispersing the one or more rheology modifier to form a second mixture. The method also includes adding one or more pigments and a silica gel to the second mixture and stirring the second mixture to form a pigmented solution, where a fineness of the pigmented solution is at least 5 on the Hegman scale. The method also includes adding a polymeric binder to the pigmented solution, further stirring the pigmented solution until a uniform liquid mixture can be obtained and filtering the liquid mixture through a filter to form the liquid coating composition.

In another aspect, an exemplary film is provided. The film includes one or more layers including one or more dried coating compositions, where each of the one or more dried coating compositions includes a silica gel that reversibly adsorbs and desorbs water. The silica gel is present in the film from about 10 wt. % to about 60 wt. %, and the silica gel has an open pore volume from about 0.2 mL/g to about 1.0 mL/g. The film also includes a polymeric binder present in the film from about 10 wt. % to about 70 wt. %. The film also has a dry coat weight from about 50 g/m² to about 1000 g/m². The film also has a wet cup water vapor permeance of at least 50 U.S. perms multiplied by the quotient of 100 g/m² and the dry coat weight of the film.

In some aspects, the silica gel can reversibly adsorb and desorb from about 15% to about 200% of its dry weight in water. In some aspects, the silica gel can reversibly adsorb and desorb from about 25% to about 50% of its dry weight in water. In some aspects, the silica gel can include a plurality of particles having an average particle size from about 1 micrometer to about 20 micrometers, from about 3 micrometers to about 15 micrometers, or from about 5 micrometers to about 10 micrometers.

In some aspects, the polymeric binder can include a plurality of particles having an average particle size from about 200 nm to about 350 nm.

In some aspects, the silica gel can be present in the film in an amount from about 10 wt. % or from about 60 wt. % or from about 15 wt. % to about 50 wt. %. In some aspects, the silica gel can include a plurality of particles, each particle having a specific surface area from about 500 m²/g to about 900 m²/g.

In some aspects, the polymeric binder can include one or more polymeric latexes, the one or more polymer latexes including pure acrylic, vinyl acrylic, styrene acrylic, or any combination thereof.

In some aspects, the film can have a dry coat weight from about 75 g/m² to about 350 g/m².

In some aspects, each of the one or more dried coating compositions can include dispersed particles of one or more organic or inorganic pigments or a mixture of different organic and/or inorganic pigments.

In some aspects, the one or more inorganic pigments can include titanium dioxide, iron oxide, zinc oxide, cobalt blue, cobalt violet, cobalt green, manganese violet, purple of Cassius, Prussian blue, Persian blue, malachite, Green earth, titanium yellow, zinc yellow, or any combination thereof.

In some aspects, the one or more organic pigments can include monoazo, disazo, laked azo, β-naphthol, naphthol AS, benzimidazolone, disazo condensation, azo metal complex pigments, polycyclic pigments, or any combination thereof. In some aspects, the polycyclic pigments can include phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, triarylcarbonium, diketopyrrolopyrrole pigments, carbon black pigments, or any combination thereof.

In some aspects, the carbon black pigments can include gas black pigments, furnace black pigments, monoazo pigments, disazo pigments, or any combination thereof. In some aspects, a Colour Index of the carbon black pigments can be Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34, Pigment Brown 41, or any combinations thereof.

In some aspects, a Colour Index of the isoindolinone pigments or the isoindoline pigments can be Pigment Yellow 139 Pigment Yellow 173, or any combination thereof.

In some aspects, a Colour Index of the phthalocyanine pigments can be Pigment Blue 15, Pigment Blue 15:1, Pigment Blue 15:2, Pigment Blue 15:3, Pigment Blue 15:4, Pigment Blue 15:6, Pigment Blue 16, Pigment Green 7, Pigment Green 36, or any combination thereof.

In some aspects, a Colour Index of the anthanthrone, anthraquinone, quinacridone, dioxazine, indanthrone, perylene, perinone, or thioindigo pigments can be Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23, Pigment Orange 43, or any combination thereof.

In some aspects, a Colour Index of the triarylcarbonium pigments can be Pigment Red 169, Pigment Blue 56, Pigment Blue 61, or any combination thereof.

In some aspects, a Colour Index of the diketopyrrolopyrrole pigments can be Pigment Red 254, Pigment Red 255, Pigment Red 264, Pigment Red 270, Pigment Red 272, Pigment Orange 71, Pigment Orange 73, Pigment Orange 81, or any combination thereof.

In some aspects, a Colour Index of the β-naphthol pigments or the naphthol AS pigments can be Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38, Pigment Brown 1, or any combinations thereof.

In some aspects, a Colour Index of the laked azo metal complex pigments or the azo metal complex pigments can be Pigment Red 48:2, Pigment Red 48:3, Pigment Red 48:4, Pigment Red 57:1, Pigment Red 257, Pigment Orange 68, Pigment Orange 70, or any combination thereof.

In some aspects, a Colour Index of the benzimidazoline pigments can be Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, Pigment Brown 25, or any combination thereof.

In some aspects, a particle size of the dispersed particles of one or more organic or inorganic pigments or a mixture of different organic and/or inorganic pigments can be about 10 micrometers or less.

In some aspects, the film can have a wet cup water vapor permeance of at most 1000 U.S. perms multiplied by the quotient of 100 g/m² and the dry coat weight of the film.

In some aspects, each of the one or more dried coating compositions can include one or more dispersants. In some aspects, the one or more dispersants can include potassium tripolyphosphate, one or more salts of carboxylic acid, or any combination thereof. In some aspects, the one or more dispersants can be present in the film from about 0.02 wt. % to about 10 wt. %, or from about 0.2 wt. % to about 4 wt. %.

In some aspects, each of the one or more dried coating compositions can include one or more rheology modifiers. In some aspects, the one or more rheology modifiers can include one or more inorganic rheology modifiers. In some aspects, the one or more inorganic rheology modifiers can include modified clays, unmodified clays, or any combination thereof. In some aspects, the one or more rheology modifiers can include one or more organic rheology modifiers including cellulosic polymers, acrylic polymers, urethane polymers, or any combination thereof. In some aspects, the rheology modifiers can be present in the film from about 0.02 wt. % to about 10 wt. %, or from about 0.04 wt. % to about 4 wt. %.

In some aspects, each of the one or more dried coating compositions can include one or more foam-controlling additives or defoamers. In some aspects, the one or more foam-controlling additives or defoamers can be present in the film in an amount of about 1 wt. % or less.

In some aspects, each of the one or more dried coating compositions can include one or more anionic or nonionic surface tension-controlling additives. In some aspects, the one or more surface tension-controlling additives can include alkali metal, amine salts of alkyl, ammonium salts of alkyl, aryl, alkaryl, aralkyl sulfates, sulfonates, phosphates, phosphonates, ethoxylated fatty acids, esters, alcohols, amines, amides, phenols, sulfur-containing compounds, ether units, polyether units, propoxyl, or any combination thereof. In some aspects, the one or more surface tension-controlling additives can be present in the film in an amount of about 1.5 wt. % or less.

In some aspects, each of the one or more dried coating compositions can include one or more coalescence promoters. In some aspects, the one or more coalescence promoters can include Polyethylene Glycol, Polypropylene Glycol, or esters or ethers of di-, tri-, or poly-ethylene or propylene glycols, or any combination thereof. In some aspects, the one or more coalescence promoters can be present in the film in an amount of about 4 wt. % or less.

In some aspects, each of the one or more dried coating compositions can include one or more biocides. In some aspects, the one or more biocides can include Methylbenzimidazole-2-yl Carbamate, 3-Iodo-2-propynyl butyl carbamate, 1,2-Benzisothiazolin-3-one (BIT), 2,2-Dibromo-3 nitrilopropi-onamide (DBNPA), or any combination thereof. In some aspects, the one or more biocides can be present in the film in an amount less than about 1 wt. %.

In some aspects, each of the one or more dried coating compositions can include one or more pH modifiers. In some aspects, the one or more pH modifiers can include inorganic acids, organic acids, inorganic bases, organic bases, or any combination thereof. In some aspects, the inorganic acids can include ammonia, the organic acids can include acetic acid, maleic acid, citric acid, or a combination thereof, the inorganic bases can include sodium hydroxide, potassium hydroxide, ammonium hydroxide, or any combination thereof, and the organic bases can include amines. In some aspects, the one or more pH modifiers can be present in the film in an amount of about 6 wt. % or less.

In some aspects, the film can have a fineness of grind of Hegman 4 or higher.

In some aspects, the polymeric binder can be present in the film in an amount from about 10 wt. % to about 70 wt. % or from about 10 wt. % to about 40 wt. %.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated into and constitute a part of this specification, show certain implementations of the subject matter disclosed herein and, together with the description, help explain some of the principles associated with the disclosed implementations. In the drawings:

FIG. 1 is a diagram illustrating an exemplary wall structure, consistent with the implementations of the current subject matter; and

FIG. 2 is a graph illustrating results of WUFI simulation of the relative humidity with different silica gel loadings as carried out in Example 10 (test 3).

It is noted that the drawings are not necessarily to scale. The drawings are intended to depict only typical implementations of the subject matter disclosed herein, and therefore should not be considered as limiting the scope of the disclosure. When practical, similar reference numbers denote similar structures, features, or elements.

### DETAILED DESCRIPTION

Practical solutions are sought for the problems of water condensation, moisture accumulation, and humidity in bathrooms and other parts of buildings which are susceptible to extensive moisture exposure. A specific problem experienced in buildings, for example, is preventing condensation on the painted walls and ceiling of a bathroom during a hot shower.

Another specific problem is preventing excessive humidity or moisture accumulation in the facing paper of gypsum wallboard, insulation, or other materials of the walls and ceiling that are susceptible to fungal growth. Excessive humidity is a level beyond which fungal growth occurs on building materials, which is approximately 80% relative humidity for fungal growth on wood or wood-based products. Excessive moisture accumulation is a level beyond which fungal growth will be observed on a particular material. Existing approaches to solve these problems have drawbacks that can make them unsatisfactory. For example, exhaust fans expel humid air from bathrooms, but these devices consume energy, are prone to mechanical malfunctions and electrical failures, are expensive to install as a retrofit in buildings lacking the appropriate ductwork, and can leave dead spots inadequately ventilated due to the air flow patterns in a particular space. Dehumidifiers remove water vapor from the air but are energy-intensive, prone to mechanical or electrical failure, and often considered unattractive, making them less desirable for use in rooms. Interior coatings including primers and paints may contain pesticides that provide a chemical form of anti-microbial protection to the paint surface, but they do not address condensation, moisture accumulation, or humidity which can stimulate fungal growth on untreated surfaces.

Desiccant materials are effective at preventing condensation, moisture accumulation, and high humidity in applications such as packaging (e.g., silica gel packets in boxes of new shoes), display cases in museums and libraries, and in packaged foods like beef jerky. Practical applications of desiccants for interior climate control have been impeded by multi-faceted technical challenges. These challenges include, for example, the absence of convenient methods for uniformly and widely distributing substantial desiccant quantities within a building or a portion thereof, the importance of achieving a humidity-buffering effect characterized by a high moisture storage capacity and minimal hysteresis in the sorption isotherm, and the simultaneous importance of providing aesthetic value to the interior walls and/or ceilings of buildings. A liquid coating composition (e.g., a paint) that integrates desiccant properties while providing a visually appealing finish could address these issues. Liquid coating compositions can cover large interior surfaces, directly interacts with the air, and is easy to apply, making it a desirable medium for climate regulation.

Expanding upon the multi-faceted technical challenges, whereas a conventional paint typically adsorbs water vapor with a capacity below about 3% of the dry paint film weight, liquid coating compositions described here function as climate-regulating paints and are capable of adsorbing at least twice as much water. To achieve a high humidity buffering capacity, climate-regulating paints need to be able to incorporate large quantities of desiccant materials in their composition, thereby resulting in climate-regulating paint compositions that significantly differ from conventional paint compositions. Superabsorbent polymers and hydrogels are a class of desiccants with a very high moisture absorption capacity, but they undergo significant swelling and softening upon water absorption, making them unsuitable for use on a finished interior surface. Many mineral desiccants, including Montmorillonite, Kaolin and Bentonite clays, also swell upon hydration, raising concerns if used in large quantities in a paint. Additionally, most desiccants have a hysteric absorption profile, meaning that these materials will tend to absorb water, but will not be as good at releasing that water, unless the material is heated. Additionally, these conventional desiccants are also not inherently compatible with paint, as the desirable properties of paints and the properties of most desiccant materials are often in conflict, which can make the compositions difficult to manufacture. Specifically, a paint's ability to provide a good decorative coating is directly related to the paint's rheology, or how well the paint flows, while most desiccants are thixotropic, meaning that they tend to solidify and lock in a shape, like a clay and or paste, and not good at leveling out, which is not desirable for aesthetic paints. The strongly thixotropic property that desiccant materials, including clays and silica gel materials, tend to impart to waterborne compositions. Thixotropy is a non-Newtonian rheological property where a material significantly thickens or solidifies at low shear rates, and the thixotropic character of many desiccants makes it difficult to achieve paint compositions that apply evenly and achieve a smooth finish with good aesthetic properties. Another challenge is to achieve a moisture control paint with low hysteresis in the adsorption and desorption of water.

As described above, many desiccant materials exhibit a significant degree of hysteresis, holding less water at certain humidity levels when the humidity in the environment is rising than when the humidity is falling. Another challenge is to achieve a climate-regulating paint that absorbs and releases water over an intermediate range of ambient humidities at which it is desirable to keep an interior environment. Whereas many desiccant materials strongly absorb water at relative humidity levels of about 30% or less, between about 0% and about 30% relative humidity, it is desirable for a climate-regulating paint to strongly absorb water between about 30% and about 60% relative humidity.

Another challenge relates to the rate with which the paint absorbs and releases water. To be effective at regulating humidity in a bathroom during a hot shower, for example, the paint on the ceiling and walls needs to absorb a quantity of water comparable to the amount of vapor released by the shower within about twenty minutes. This is difficult because many conventional decorative paints retard the flow of water vapor, and because many moisture-absorbing materials take hours or days to reach their equilibrium moisture content.

Another challenge relates to the need to restrict the quantity of volatile organic compounds (VOC) in paints. A paint with low VOC content is desirable because it can significantly reduce the emission of harmful chemicals into the air, improving indoor air quality and minimizing potential health risks like irritation to eyes, nose, and throat, headaches, and nausea, especially for people with allergies or sensitivities, while also contributing to a cleaner environment by reducing air pollution. Paints may also need to comply with certain environmental regulations that impose limits on the maximum VOC content. For example, according to the limits set by the California Air Resources Board, a flat paint must contain less than 50 g/L of VOC, less water and exempt compounds. It is difficult to formulate a waterborne paint with high desiccant content and low VOC content because many non-aqueous co-solvents, open time extenders, and coalescing agents that are commonly used to improve the flow and drying properties of paint have high VOC content.

The present disclosure is directed to liquid coating compositions that generally include a combination of materials that utilize a large amount of desiccant, namely silica gel, in such a way that the resultant films made therefrom have significantly improved moisture regulation properties, while providing aesthetic rheological properties. In general, the present liquid coating compositions at least include water, silica gel, and a polymeric binder. These present liquid coating compositions can be used as a paint that address one or more of the foregoing challenges associated with conventional paint.

The present liquid coating compositions disclosed herein are used to form films. These films include one or more layers, where each layer includes one or more dried coating compositions. As used herein a “dried” coating composition” is any liquid coating composition disclosed herein which has been applied to a surface (e.g., an interior surface of a building or part of a building) and dried either passively or actively to produce a film (solid film). For example, a film (solid film) can have a water content below 30% by weight of the film, or below 25% by weight of the film, or below 20% by weight of the film, or below 15% by weight of the film. In a further aspect, a film (solid film) can demonstrate a hardness exceeding that of the 6B pencil as measured via ASTM D3363-22. During use, for example, upon exposure to humidity, the dried coating composition absorbs and desorbs water such that the resulting film can have a moisture storage capacity of at least 5 wt. %. In some aspects, the resulting film can have a moisture storage capacity from about 5 wt. % to about 30 wt. %, or from about 6 wt. % to about 25 wt. %, or from about 10 wt. % to about 20 wt. %. In further aspects, the resulting film can have a moisture storage capacity from about 7 wt. % to about 17 wt. %.

As noted above, the liquid coating compositions disclosed herein can be applied to interior surfaces (e.g., interior walls and/or ceilings) of the building or a portion thereof and drying the liquid coating compositions, either passively or actively, to form a film (e.g., a decorative paint). When the term “paint” is used herein to describe specific applications of the liquid coating compositions described herein, it is noted that the term “paint” does not mean that the liquid coating composition includes a pigment. For example, in some aspects, the liquid coating composition does not include any pigment. In further aspects, the liquid coating composition can include one or more pigments. In some aspects, the coating compositions, and thus, the resulting films made therefrom, can regulate the climate inside of a building or a portion thereof.

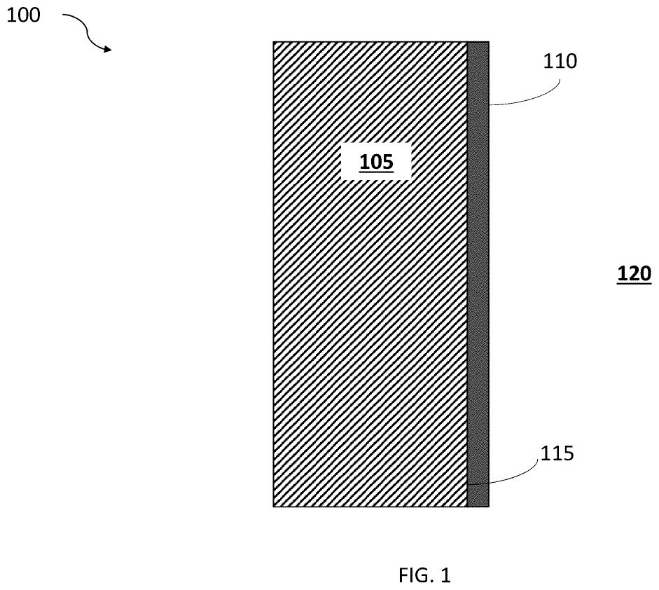

For example, FIG. 1 is a schematic illustrating an exemplary wall structure 100. As shown in FIG. 1, the wall structure 100 can include a wall 105 and a film 110. The film 110 includes one or more layers of one or more dried coating compositions, as described herein, applied to an interior surface 115 of the wall 105. By way of example, the film 110 can be formed by applying (e.g., brushing, spraying, rolling, and/or the like) interior walls and/or ceilings with one or more layers of the liquid coating compositions described herein, to at least a portion of one or more interior surfaces of a building or part of the building, and thereafter, drying the one or more liquid coating compositions, either actively or passively, to form the film (e.g., the one or more layers of one or more dried coating compositions). This can allow the silica gel to be conveniently, safely, and evenly deposited inside of a building or part thereof (e.g., a house) to prevent condensation and provide interior climate control and desired aesthetics. The resulting films can absorb excess moisture when humidity inside the building (e.g., in a space 120 adjacent to a film 110 applied to an interior surface 115 of a wall structure 100) spikes, like during a shower, for example, and can release stored moisture gradually by evaporation when humidity drops. The cycles of absorbing/releasing moisture can repeat many times over an extended material lifetime. The liquid coating compositions, when applied and dried also provide aesthetic value as a decorative paint.

In some aspects, the films of the present disclosure can improve occupant comfort within the building (e.g., in the space 120 in FIG. 1) by reducing an amplitude of relative humidity fluctuations. Alternatively, or in addition, the films can also prevent mold growth, mildew, and other forms of moisture damage that are problems in damp areas such as bathrooms and basements. Alternatively, or in addition, the films can also improve air quality by maintaining a moderate relative humidity inside of the building (e.g., in the space 120) of between about 30% and 60%, thereby reducing a concentration of particulate matter or a concentration of toxins released by microorganisms. Alternatively, or in addition, the films can also increase a thermal efficiency of the building and/or reduce the average and peak energy demands for heating and cooling in the building by passively regulating a relative humidity inside of the building (e.g., in the space 120 in FIG. 1) and by storing and releasing the latent heat of water vapor in ways that reduce an average load on a heating and cooling system of the building. Alternatively, or in addition, the films can also increase the moisture-durability of the building by suppressing the water condensation on the ceilings and walls (e.g., wall 105 in FIG. 1) of the building and by suppressing peak humidity levels within the building, which stimulate fungal growth.

The present disclosure further describes a method for regulating the climate inside a building or a part thereof and/or reducing condensation, humidity, mold growth, and other moisture-related problems in buildings, including in bathrooms, kitchens, basements, and other wet areas of the building. While this exemplary method is described with reference made to FIG. 1, a person skilled in the art would understand that such method is not limited by the illustrated components. For example, in some aspects, the wall 105 can be a wall and/or ceiling of a bathroom, kitchen, basement, or other wet area of a building. In some aspects, the film 110 can be applied to the wall 105 by applying (e.g., brushing, spraying, rolling, and/or the like) one or more layers of one or more liquid coating compositions described herein to at least a portion of the interior surface of the wall 105 and/or ceilings of the building or a portion thereof and drying the one or more layers, either actively or passively, to form the film 110 as described above. In some aspects, the liquid coating compositions can be deposited onto the wall 105 using standard application methods such as brush application, foam roll application, or spray application. Once deposited and dried, the film 110 can absorb and release moisture and heat depending on the relative humidity of the environment. The film 110 can be used to control humidity, mold growth, and energy use for heating and cooling in a variety of structures. For example, in some aspects, the wall structure 100 can be a wall of a residential building, commercial building, medical building, hotel, restaurant, school, industrial building, recreational building, transportation building, religious building, and any others.

To quantify the influence of films obtained from the present coating formulations on humidity and moisture accumulation in the wall materials behind the film, the heat and moisture transport that can occur in a building under various use cases can be calculated using the physics simulation software package, WUFI. For example, a hot shower releases a large quantity of water vapor that must go somewhere and can cause problems including mold, mildew, and other forms of moisture damage if it accumulates inside building materials in the walls or ceiling. Moisture problems can occur on the front or back of gypsum wallboard, where the facing paper provides a surface hospitable to mold growth when the enough moisture is available. The films applied as disclosed herein can absorb water vapor and sequester it away from building materials that are susceptible to moisture damage when the humidity is high and then release the stored moisture gradually when the humidity falls. The films can thereby reduce the peak humidity and suppress moisture condensation inside the wall.

In some aspects, a dry coat weight of the film can be from about 50 g/m² to about 1000 g/m², from about 75 g/m² to 350 g/m², or from about 100 g/m² and 300 g/m², however, other dry coat weights of the film are also realized.

The dry coat weight is a factor for determining the total capacity of the film to store and release moisture inside a building or part of a building. In some aspects, the film can prevent moisture condensation or high humidity inside a bathroom during a hot shower when the total moisture storage capacity is similar to the quantity of water vapor released by the hot shower, which is typically from 200 g to 400 g of water (assuming water vapor is released at a rate of 2.4 kg/hr and that a shower lasts from 5 to 10 minutes). For example, in a rectangular bathroom that is 3 m long, 2 m wide, and 2 m high, a film with a moisture storage capacity of 12.5% that is applied to the ceiling and to 60% of the wall area with a dry coat weight of 200 g/m² will have a capacity to store and release about 525 g of water, an amount of water that exceeds what is released in a typical shower. In another aspect, a film can buffer the relative humidity in an interior room when the total moisture storage capacity of the film is similar to the quantity of water vapor held in the air inside that room, which is about 144 g inside a room with the same dimensions listed above at 20 C and 50% relative humidity. In this example, a film with a moisture storage capacity of 14% and a coat weight of 50 g/m², applied to the ceiling and 60% of the wall area, can have have a capacity to store and release about 147 g of water, which exceeds the water vapor held in the air. A single layer of a liquid coating composition disclosed herein generally gives a dry coat weight between 50 g/m² and 100 g/m². The application of multiple layers of the liquid coating compositions disclosed herein can build up films with higher coat weights. The dry coat weight can be built up quickly, over hours or days, or over many years, to produce films with dry coat weights as heavy as 1000 g/m².

The water vapor permeability of a film can enable the film to absorb water vapor sufficiently at a high enough rate to suppress the peak humidity and prevent moisture condensation when the relative humidity in the environment rises to a high level in the range 80% to 100%. The water vapor permeability of the film can be obtained by multiplying the water vapor permeance of a film by its thickness. The water vapor permeance of a film can be measured via ASTM E 96-00, the wet cup method. The permeability of the film control how quickly the film is able to fill its moisture storage capacity with water vapor adsorbed from the environment. For example, when the permeance of a first film with a dry coat weight of 100 g/m² is 50 U.S. perms, it can absorb up to about 16.5 g/hr/m² of water vapor, which enables it to use its full moisture storage capacity in a timescale of about 1 hr. As another example, when the permeance of a second film with a dry coat weight of 100 g/m² is 100 U.S. perms, it can absorb up to about 33 g/hr/m² of water vapor, which enables it to use its full moisture storage capacity in about 30 minutes. As a further example, when the permeance of a third film with a dry coat weight of 100 g/m² is 200 U.S. perms, it can absorb up to about 67 g/hr/m² of water vapor, which enables it to use its full moisture storage capacity in about 15 minutes. When films with a dry coat weight of 100 g/m² have permeance values in the range of the above examples, the films are useful for regulating humidity and preventing condensation in buildings. When a fourth film has a different dry coat weight, the equivalent permeance is the product of the permeance first, second, or third film with a 100 g/m² dry coat weight, multiplied by the quotient of 100 g/m² and the dry coat weight of the fourth film.

In aspects, a film can include one or more layers, where the one or more layers include one or more dried coating compositions. Each of the one or more dried coating compositions can include a silica gel that reversibly adsorbs and desorbs water, where the silica gel is present in the film from about 10 wt. % to about 60 wt. %, the silica gel having an open pore volume from about 0.2 mL/g to about 1.0 mL/g; and a polymeric binder present in the film from about 10 wt. % to about 70 wt. %. In such aspects, the film can have a dry coat weight from about 50 g/m² to about 1000 g/m²; and the film can have a wet cup water vapor permeance of at least about 50 U.S. perms multiplied by the quotient of 100 g/m² and the dry coat weight of the film. In further aspects, the film can have a wet cup water vapor permeance of at least about 100 U.S. perms multiplied by the quotient of 100 g/m² and the dry coat weight of the film. In further aspects, the film can have a wet cup water vapor permeance of at least about 200 U.S. perms multiplied by the quotient of 100 g/m² and the dry coat weight of the film. In further aspects, the film can have a wet cup water vapor permeance of at most about 1000 U.S. perms multiplied by the quotient of 100 g/m² and the dry coat weight of the film. In further aspects, the film can have a wet cup water vapor permeance of at most about 500 U.S. perms multiplied by the quotient of 200 g/m² and the dry coat weight of the film. In further aspects, In further aspects, the film can have a wet cup water vapor permeance of at most about 100 U.S. perms multiplied by the quotient of 1000 g/m² and the dry coat weight of the film.

As described above, the liquid coating compositions of the present disclosure include at least water as the dispersing medium. In some aspects, the water can be of any grade that provides desirable dispersion of the components of the liquid coating compositions of the present disclosure. The grade of water can be de-ionized or distilled water that meets or exceeds ASTM specifications for Type IV deionized water. The amount of water present in the liquid coating compositions can be from about 30 wt. % to about 70 wt. %, from about 35 wt. % to about 65 wt. %, or from about 40 wt. % to about 60 wt. %. It is also contemplated herein that the amount of water present in the liquid coating compositions described herein does not fall outside any of these recited ranges.

In some aspects, the silica gel can be present in the liquid coating compositions described herein in an amount from about 5 wt. % to about 30 wt. %. In further aspects, the amount of silica gel in the liquid coating composition can be from about 7 wt. % to about 30 wt. %, from about 10 wt. % to about 30 wt. %, from about 15 wt. % to about 30 wt. %, or from about 20 wt. % to about 30 wt. %. In further aspects, the silica gel can be present in the liquid coating compositions described herein in an amount from about 8 wt. % to 25 wt. %. In further aspects, once the liquid coating composition is applied to a surface and dried, as described herein, thereby forming a film, the silica gel can be present in the film in an amount from about 10 wt. % to about 60 wt. % (i.e., from about 10 wt. % to about 60 wt. % of the dry weight of the film). In further aspects, the amount of silica gel present in the film can be from about 15 wt. % to about 60 wt. %, from about 20 wt. % to about 60 wt. %, from about 30 wt. % to about 60 wt. %, or from about 40 wt. % to about 60 wt. %. In further aspects, the silica gel can be present in the film in an amount from about 15 wt. % to 50 wt. %. It is also contemplated herein that the amount of silica gel in the liquid coating compositions described herein and the amount of silica gel in the films described herein does not fall outside any of these recited ranges.

The silica gel includes particles. In some aspects, the particles can have an average particle size from about 1 micrometer to about 20 micrometers. The average particle size is measured by the laser diffraction method (e.g., via ASTM D4464-15). In further aspects, the average particle size can from about 3 micrometers to about 15 micrometers or from about 5 micrometers to about 10 micrometers. The silica gel particles also have a specific surface area. The specific surface area of silica gel particles can be measured via ASTM C1274-10. The specific surface area of the silica gel particles of the liquid coating compositions of the present disclosure can be from about 400 m²/g to about 900 m²/g, from about 500 m²/g to about 900 m²/g, from about 600 m²/g to about 900 m²/g, from about 700 m²/g to about 900 m²/g. In further aspects, the specific surface area of the silica gel particles of the liquid coating compositions of the present disclosure can be from about 700 m²/g to about 800 m²/g. It is also contemplated herein that the specific surface area of the silica gel particles described herein does not fall outside any of these recited ranges.

The silica gel of the liquid coating compositions of the present disclosure has an open pore volume. The open pore volume of a silica gel specimen can be measured via ASTM D6761-22. The open pore volume of the silica gel can be from about 0.2 mL/g to about 1.0 mL/g. In further aspects, the open pore volume can be from about 0.1 mL/g to about 2.0 mL/g, from about 0.1 mL/g to about 1.6 mL/g, from about 0.2 mL/g to about 1.2 mL/g, or from about 0.2 mL/g to about 0.6 mL/g. It is also contemplated herein that the open pore volume of the silica gels described herein does not fall outside any of these recited ranges. It was surprising to find that high moisture storage capacity and good rheological properties of the coating compositions described herein could be effected with a silica gel having an open pore volume of less than about 1 mL/g. This is because a person skilled in the art would have expected the need for a higher pore volume to formulate a liquid coating composition, resulting in a film having a high moisture storage capacity. It was also surprising to find that the pore volume, which characterizes the nanoscopic internal structure of silica gel particles, could influence rheological flow properties, which characterize macroscopic relative motions of particles and liquids within the liquid coating compositions.

In some aspects, the mean pore diameter of the silica gel can be from about 1 nm to about 10 nm or from about 2 nm to about 5 nm. The mean pore diameter can be measured via ASTM D4222-20. It is also contemplated herein that the mean pore diameter of the silica gels described herein does not fall outside any of these recited ranges.

Unexpectedly, as discussed herein, it was discovered that the properties of the silica gel materials (e.g., specific pore volume, and optionally particle size and/or specific surface area) can be capable of being dispersed in large quantities in water-based paint compositions down to a fineness of grind of Hegman 4 or higher; form free-flowing paint dispersions (i.e., a fluid with a Newtonian or mildly shear-thinning rheology profile and a Stormer viscosity in the range 60 KU-150 KU) that allow easy paint application and good leveling properties; and form stable aqueous paint dispersions that do not solidify or significantly phase separate, with shelf life stability of at least 6 months; and form dry films with a high moisture storage capacity of at least 5 wt. %. By contrast, paint compositions that include a generic desiccant suffer from poor rheological properties or a low moisture storage capacity. For example, a paint composition with about 50 wt. % water and only about 5 wt. % silica gel desiccant will yield a film that absorbs less than about 4% of its dry weight in water, which is too little to be useful for regulating humidity inside a building. A contrasting example is a paint composition with about 50 wt. % water and about 20 wt. % generic silica gel desiccant, which is highly thixotropic and exhibits poor leveling and aesthetic properties.

The silica gel of the liquid coating compositions disclosed herein is configured to reversibly adsorb and desorb water, for example, when exposed to changes in relative humidity. For example, in use, when the film is exposed to a humidity greater than the equilibrium humidity of its present moisture content, the film will adsorb water vapor from the environment. The relationship between the present moisture content of the film and the equilibrium humidity is defined by the moisture adsorption isotherm when the film is exposed to a humidity greater than the equilibrium humidity of its present moisture content. As another example, in use, when the film is exposed to a humidity lower than the equilibrium humidity of its present moisture content, the film will release water into the environment by evaporation. The relationship between the present moisture content of the film and the equilibrium humidity is defined by the moisture desorption isotherm when the film is exposed to a humidity lower than the equilibrium humidity of its present moisture content. The moisture adsorption and desorption isotherms of the film can be measured via ASTM C1498-04a.

In some aspects, the silica gel can reversibly adsorb and desorb water from about 15% to about 200% of its dry weight in water, from about 20% to about 60% of its dry weight in water, from about 30% to about 50% of its dry weight in water, or from about 25 wt. % to about 40 wt. % of its dry weight in water. It is also contemplated herein that the amount of water the silica gel described herein can reversibly adsorb and desorb does not fall outside any of these recited ranges. A non-limiting example of a silica gel includes a synthetic amorphous silica (for example, Syloid® AL-1 available from W. R. Grace & Co.—Conn.).

In some aspects, the liquid coating composition can have a shelf life of about 6 months. The phrase “shelf life” when used in reference to the shelf life of the liquid composition means that no gelling or phase separation occurs when stored in an airtight container at a temperature from 5° C. to 30° C. In some other aspects, a composition with a shelf life of about 6 months can have a Stormer viscosity from 60 KU to 140 KU after the composition is stored in an airtight container at a temperature from 5° C. to 30° C. for 6 months.

In some aspects, the liquid coating compositions described herein can have a Stormer viscosity in the range from about 80 KU to about 120 KU. In further aspects, the Stormer viscosity can be in the range from about 60 KU to about 140 KU or from about 70 KU to about 130 KU. It is also contemplated herein that the Stormer viscosity of the liquid coating compositions described herein does not fall outside any of these recited ranges.

In some aspects, an amount of the polymeric binder in the liquid compositions described herein can be from about 4 wt. % to about 50 wt. %. In further aspects, the polymeric binder can be present in the liquid coating composition in an amount from about 5 wt. % to about 35 wt. %, from about 5 wt. % to about 25 wt. %, or from about 5 wt. % to about 15 wt. %. In further aspects, once the liquid coating composition is applied to a surface and dried, as described herein, thereby forming a film, an amount of polymeric binder in the resulting film can be from about 10 wt. % to about 70 wt. % (i.e., from about 10 wt. % to about 70 wt. % of the dry weight of the film). In further aspects, the polymeric binder can be present in the film in an amount from about 10 wt. % to about 60 wt. %, from about 10 wt. % to about 40 wt. %, or from about 10 wt. % to about 20 wt. %.

The polymeric binder includes particles. The particles can having an average particle size from about 200 nm to about 350 nm, from about 220 nm to about 340 nm, or from about 250 nm to about 300 nm. The average particle size is measured by the laser diffraction method (e.g., via ASTM D4464-15).

The polymer binder can include a variety of one or more suitable materials. In some aspects, any polymeric latex or combination of polymeric latexes that are compatible with silica gel can be used in the liquid coating compositions of the present disclosure. Such latexes can be based on acrylic, vinyl acrylic, styrene acrylic, styrene butadiene, styrene butadiene acrylic, polyvinyl acetate (PVA) polymeric resins, or PVA acrylic. In further aspect, the latex can be based on acrylic, vinyl acrylic, or styrene/acrylic resin. The latex particle size can be from about 0.05 micrometers to about 0.35 micrometers. Further non-limiting examples of suitable latexes include but are not limited to Rhoplex 101, Rovace 9900, Rovace 9100AF, or Evoque 3150 available from Dow Chemicals; Neocar 820, Encor 310, or Encor 496 available from Arkema; or Acronal Plus 4130 or Acronal Plus 4230 available from BASF.

It was also discovered, as discussed herein, that latex particles with a mean particle size from about 200 nm to about 350 nm can achieve significantly more Newtonian and less viscous liquid coating compositions than smaller latex particles. In some aspects, the use of latex particles having an average particle size from about 200 nm to about 350 nm can enable the liquid coating compositions described herein to exhibit good flow properties with little (less than 1% by weight) or no added co-solvent. The use of latex particles smaller than 200 nm can result in liquid coating compositions that can be too thixotropic to apply evenly (e.g., by roll or brush) unless a large amount of a VOC-containing co-solvent is added to the composition (e.g., 5%-10% by weight of propylene glycol) to improve the rheology and drying properties. As such, the use of latex particles in a particular size range, e.g., 200 nm to 350 nm, can be beneficial for creating liquid coating compositions with a coating VOC content below 50 g/l or below 5 g/L.

Additionally, in some aspects, the liquid coating compositions disclosed can include one or more of additional components described below. In some aspects, the one or more additional components include one or more co-solvents, one or more inorganic pigments, one or more inorganic pigments, one or more dispersants, one or more rheology modifiers, one or more additives, one or more coalescence promoters, one or more biocides, or one or more pH modifies, any combination thereof. The one or more additives can include one or more foam-controlling additives, one or more surface tension-controlling additives, or a combination thereof.

In some aspects, the liquid coating compositions can include one or more co-solvents. Non-limiting examples of suitable co-solvents can include propylene glycol, ethylene glycol, isopropanol, ethanol, propylene carbonate, or 2-amino-2-methyl-1-propanol. In one aspect, the co-solvent can be present in the liquid coating composition at an amount from about 1 wt. % to about 10 wt. %. In further aspects, once the liquid coating composition is applied to a surface and dried, as described herein, thereby forming a film, an amount of co-solvents in the resulting film can be greater than 0 wt. % and less than about 20 wt. % In further aspects, the amount of co-solvents in the resulting film can be from about 0.01 wt % to about 20 wt. %.

Additionally, in some aspects, the liquid coating composition disclosed can include a finely divided organic or inorganic pigment or a mixture of different organic and/or inorganic pigments. Suitable organic pigments include monoazo, disazo, laked azo, β-naphthol, naphthol AS, benzimidazolone, disazo condensation, and azo metal complex pigments, and polycyclic pigments such as phthalocyanine, quinacridone, perylene, perinone, t anthanthrone, anthraquinone, flavanthrone, indanthrone, isoviolanthrone, pyranthrone, dioxazine, quinophthalone, isoindolinone, isoindoline, triarylcarbonium and diketopyrrolopyrrole pigments, for example, carbon blacks, or any combination thereof.

Non-limiting examples of suitable organic pigments can be made of carbon black pigments, such as gas blacks or furnace blacks; monoazo and disazo pigments. In some aspects, these pigments can include one or more of the following Colour Index pigments: Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34, Pigment Brown 41, or any combinations thereof.

In some aspects, the β-naphthol and naphthol AS pigments can include one or more of the following Colour Index pigments: Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38, Pigment Brown 1, or any combinations thereof.

In some aspects, the laked azo and metal complex pigments or the azo metal complex pigments can include one or more of the following Colour Index pigments: Pigment Red 48:2, Pigment Red 48:3, Pigment Red 48:4, Pigment Red 57:1, Pigment Red 257, Pigment Orange 68, Pigment Orange 70, or any combinations thereof.

In some aspects, the benzimidazoline pigments can include one or more of the following Colour Index pigments: Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, Pigment Brown 25, or any combinations thereof.

In some aspects, the isoindolinone and isoindoline pigments can include one or more of the following Colour Index pigments: Pigment Yellow 139, Pigment Yellow 173, or any combinations thereof.

In some aspects, the phthalocyanine pigments can include one or more of the following Colour Index pigments: Pigment Blue 15, Pigment Blue 15:1, Pigment Blue 15:2, Pigment Blue 15:3, Pigment Blue 15:4, Pigment Blue 15:6, Pigment Blue 16, Pigment Green 7, Pigment Green 36, or any combinations thereof.

In some aspects, the anthanthrone, anthraquinone, quinacridone, dioxazine, indanthrone, perylene, perinone, and thioindigo pigments can include one or more of the following Colour Index pigments: Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23n Pigment Orange 43, or any combinations thereof.

In some aspects, the triarylcarbonium pigments can include one or more of the following Colour Index pigments: Pigment Red 169, Pigment Blue 56, Pigment Blue 61, or any combinations thereof.

In some aspects, the diketopyrrolopyrrole pigments can include one or more of the following Colour Index pigments: Pigment Red 254, Pigment Red 255, Pigment Red 264, Pigment Red 270, Pigment Red 272, Pigment Orange 71, Pigment Orange 73, Pigment Orange 81, or any combinations thereof.

In some aspects, the one or more organic pigment can be combined with carbon black and/or titanium dioxide. Laked dyes such as Ca, Mg, and Al laked of dyes containing sulfonic and/or carboxylic acid groups can also be suitable to be combined with the one or more organic pigment.

Examples of suitable inorganic pigments can include titanium dioxide, iron oxide, zinc oxide, cobalt blue, cobalt violet, cobalt green, manganese violet, purple of Cassius, Prussian blue, Persian blue, malachite, Green earth, titanium yellow, zinc yellow, zinc sulfides, iron oxides, magnetite, manganese iron oxides, chromium oxides, ultramarine, nickel or chromium antimony titanium oxides, manganese titanium rutiles, cobalt oxides, mixed oxides of cobalt and aluminum, rutile mixed-phase pigments, sulfides of rare earth elements, spinels of cobalt with nickel and zinc, spinels based on iron and chromium with copper, zinc and manganese, bismuth vanadates, and extender pigments, or any combinations thereof.

For example, one exemplary liquid coating composition as described herein can include the Colour Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33, and Pigment White 6. However, mixtures of both inorganic as well as organic pigments are realized. In some aspects, an amount of pigment in the liquid compositions described herein can be between about 5 wt. % to about 30 wt. %. In some aspects, once the exemplary liquid coating composition is applied to a surface and dried, as described herein, thereby forming a film, the pigment can be present in the film in an amount from about 10 wt. % to about 60 wt. %.

In some aspects, the liquid coating composition disclosed can also include one or more dispersants, e.g., salts of homo- or copolymers of acrylic, methacrylic, maleic, or itaconic acids. In another aspect, dispersants can also include potassium tripolyphosphate or one or more salts of carboxylic acid. Non-limiting examples of the one or more salts can include the one or more polymers or copolymers of acrylic acid, methacrylic acid, maleic acid, itaconic acid. Examples of such dispersants include but are not limited to Tamol 945, Tamol 731a, Tamol 165a, or Tamol 1124 from Dow, or Ecodis p50 or Ecodis p90 from Arkema, or any combinations thereof. In some aspects, dispersants can be present in the liquid coating composition in an amount from about 0.01 wt. % to about 5 wt. % or from about 0.1 wt. % to about 2 wt. %. In further aspects, once the liquid coating composition is applied to a surface and dried, as described herein, thereby forming a film, an amount of dispersants in the resulting film can be from about 0.02 wt. % to about 10 wt. %, or from about 0.2 wt. % to about 4 wt. %.

In some aspects, rheological properties of the present compositions optionally can be adjusted using one or more rheology modifiers (e.g., organic and/or inorganic rheology modifiers). The one or more rheology modifiers can be present in the liquid coating composition in an amount from about 0.01 wt. % to about 5 wt. % or from about 0.02 wt. % to about 2 wt. %. The rheology modifier content present in the liquid coating composition is expressed as the dry weight of the active ingredient as a percentage the total liquid coating composition.

Inorganic rheology modifiers include such materials as modified clays, unmodified clays, or any combinations thereof. Examples of inorganic rheology modifiers can include but are not limited to hectorites, bentonites and montmorillonites.

The organic rheology modifiers can include such materials as cellulosic polymers, acrylic polymers, urethane polymers or any combination thereof. Examples of such materials can include but are not limited to Hydroxy Ethyl Cellulose, Alkali Swellable acrylic Emulsions (ASE), Hydrophobically Modified Alkali Swellable Emulsion (HASE), Hydrophobically Modified Ethoxylate Urethanes (HEUR). In some aspects, rheology modifiers can be present in the liquid coating composition in an amount from about 0.01 wt. % to about 5 wt. % or from about 0.02 wt. % to about 2 wt. %. In further aspects, once the liquid coating composition is applied to a surface and dried, as described herein, thereby forming a film, an amount of rheology modifiers in the resulting film can be from 0.02 wt. % to about 10 wt. % or from about 0.04 wt. % to about 4 wt. %.

The present disclosure can optionally include one or more additives. For example, foam-controlling additives, also called defoamers can be used. Some defoamers can be silicone or oil-based. Examples of commercial defoamers include but are not limited to Foamaster, Rhodoline 622, BYK 024, and Antifoam L30. In some aspects, the one or more foam-controlling additives can be present in the liquid coating composition in an amount of about 0.5 wt. % or less. In further aspects, once the liquid coating composition is applied to a surface and dried, as described herein, thereby forming a film, an amount of foam-controlling additives in the resulting film can be about 1 wt. % or less.

Further, in some aspects, the liquid coating compositions disclosed herein can also include one or more surface tension-controlling additives, such as wetting agents and surfactants to improve the dispersion of the pigment. For example, in some aspects, surface tension-controlling additives used can include: anionic surfactants such as the alkali metal, amine or ammonium salts of alkyl, aryl, alkaryl, aralkyl sulfates, sulfonates, phosphates or phosphonates, or nonionic surfactants such as ethoxylated fatty acids, esters, alcohols, amines, amides, phenols or the corresponding sulfur-containing compounds. The anionic surfactants can also include ether or polyether units and the nonionic surfactants can also include alkoxyl units other than ethoxyl, such as propoxyl. In some aspects, surface tension-controlling additives can be present in the liquid coating composition in an amount of about 1 wt. % or less or about 0.7 wt. % or less. In further aspects, once the liquid coating composition is applied to a surface and dried, as described herein, thereby forming a film, an amount of surface tension-controlling additives in the resulting film can be about 1.5 wt. % or less.

The liquid coating compositions described herein can also include one or more coalescence promoters, for example, to help latex binder particles of the liquid coating composition disclosed coalesce during drying to form a uniform, resilient, cohesive surface that is capable of withstanding environmental stresses, maintaining its integrity without cracking under conditions like temperature fluctuations or humidity changes. Examples of such promoters can include but are not limited to Polyethylene Glycol, Polypropylene Glycol, or esters or ethers of di-, tri-, or poly-ethylene or propylene glycols, or any combination thereof. In some aspects the Polyethylene Glycol can have a molecular weight in the range of about 100 to about 600. Additional examples of coalescence promoters can include but are not limited to Diethylene Glycol Monobutyl Ether, Trimethyl Hydroxypentyl Isobutyrate, Optifilm 400, Diethylene Glycol Hexyl ether, and dipropylene glycol dimethyl ether. In some aspects, coalescence promoters can be present in the liquid coating composition in an amount of about 2 wt. % or less. In further aspects, once the liquid coating composition is applied to a surface and dried, as described herein, thereby forming a film, an amount of coalescence promoters in the resulting film can be about 4 wt. % or less.

The liquid coating compositions described herein can also include one or more biocides to control or prevent the growth of microorganisms in the liquid coating composition, or on the film resulting from of one or more layers of one or more of the dried liquid coating compositions. Examples of such biocides can include but are not limited to Methylbenzimidazole-2-yl Carbamate, 3-Iodo-2-propynyl butyl carbamate, 1,2-Benzisothiazolin-3-one (BIT), 2,2-Dibromo-3 nitrilopropi-onamide (DBNPA), or any combination thereof. In some aspects, the biocide(s) can be present in the liquid coating composition in an amount of about 0.5 wt. % or less. In further aspects, once the liquid coating composition is applied to a surface and dried, as described herein, thereby forming a film, an amount of biocides in the resulting film can be less than about 1 wt. %.

Further, the liquid coating compositions described herein can also include one or more pH modifiers such as inorganic acids, organic acids, inorganic bases, organic bases, or any combination thereof. Examples of such inorganic acids can include ammonia. Examples of such organic acids can include acetic acid, maleic acid, citric acid, or a combination thereof. Examples of such inorganic bases can include sodium hydroxide, potassium hydroxide, ammonium hydroxide, or any combination thereof. Examples of such organic bases can include amines. sodium hydroxide, aminomethyl propanol (AMP), sodium carbonate, ammonia, hydrogen chloride, and sulfuric acid to control the pH. In some aspects, pH modifiers can be present in the liquid coating composition in an amount of about 3 wt. % or less. In further aspects, once the liquid coating composition is applied to a surface and dried, as described herein, thereby forming a film, an amount of pH modifiers in the resulting film can be about 6 wt. % or less.

In another aspect, the present disclosure discloses a method of manufacturing a liquid coating composition as described herein. In some aspects, the method can include a step of mixing water, a silica gel, and a polymeric binder to form a mixture. In some aspects, the water can be present in the mixture in an amount of at most 70 wt. % of the liquid coating composition, the silica gel can be present in the liquid coating composition in an amount from about 5 wt. % to about 30 wt. %, and the polymeric binder can be present in the liquid coating composition in an amount from about 4 wt. % to about 50 wt. %. In some aspects, the silica gel can have an open pore volume that is between about 0.2 mL/g to about 1.0 mL/g.

The present disclosure also discloses a method of manufacturing liquid coating compositions as described herein. In some aspects, the method can include a step of combining water, one or more surfactants, one or more dispersants, and one or more defoamer components in a vessel to form a first mixture. The method can also include steps of stirring the first mixture and adding one or more rheology modifier components to the mixture and thoroughly dispersing the one or more rheology modifier to form a second mixture. In some aspects, the method can optionally include a step of adding one or more pH modifiers to the second mixture until a pH level reaches a value of about 8, however, other pH levels are also realized. The method can also include a step of adding one or more pigments and a silica gel to the second mixture and stirring the second mixture to form a pigmented solution, where a fineness of the pigmented solution is at least 5 on the Hegman scale. The method can also include steps of adding a polymeric binder (and optionally one or more coalescent components) to the pigmented solution and further stirring the pigmented solution until a uniform liquid mixture is obtained. The method can also include a step of filtering the liquid mixture through a liquid filter to form the liquid coating composition. In some aspects, the stirring steps can be performed with a dispersion blade, or the like.

The liquid coating compositions and methods may be further understood with the following non-limiting examples.

### EXAMPLES

### Example 1: Preparation of Exemplary of Liquid Coating Composition #1

As shown in Table 1 below, Exemplary Liquid Coating Composition #1 included components 1-11.

TABLE 1
Exemplary Liquid Coating Composition #1

| Component # | Component class | Material | Mass (g) |
|---|---|---|---|
| 1 | Water | Water (here, from Market Basket) | 73 |
| 2 | Solvent | Propylene Glycol (here, from Sigma-Aldrich) | 24 |
| 3 | Dispersant | Sodium neutralized polyacrylate dispersing | 3 |
| | | agent (here, Ecodis p 50 from Arkema USA, Inc) | |
| 4 | Surfactant | Nonionic surfactant (here, Tergitol NP-9 from | 0.616 |
| | | Sigma-Aldrich) | |
| 5 | Defoamer | oil-hydrophobic silica blend (here, Rhodoline | 0.15 |
| | | 622 from Solvay USA, Inc.) | |
| 6 | Rheology | Hydroxyethylcellulose (here, Natrosol 250HR | 1.2 |
| | Modifier | from Ashland, Inc.) | |
| 7 | pH Modifier | Ammonium Hydroxide (here, from Sigma- | 0.1 |
| | | Aldrich) | |
| 8 | Pigment | Titanium Dioxide (here, RCL 595 from Ineos | 41.9 |
| | | Group) | |
| 9 | Desiccant | Silica Gel (here, SYLOID AL1 from Grace and | 69.6 |
| | | Co.) | |
| 10 | Binder latex | Acrylic latex (here, NEOCAR Acrylic 820 from | 58.5 |
| | | Arkema USA, Inc.) | |
| 11 | Coalescent | Glycol Either (here, Glycol Ether DB8 from | 1.26 |
| | | Sigma-Aldrich) | |

The method of making Exemplary Liquid Coating Composition #1 included the following steps: Components 1-5 were weighed into a 250 mL plastic beaker and stirred at 300 rpm with a 5 cm diameter dispersion blade to form a first mixture. Component 6 was added to the first mixture and thoroughly dispersed to form a second mixture. Component 7 was added dropwise to the second mixture until the pH reached a value of 8 to form a third mixture. Stirring continued until all of component 6 was dissolved and a uniform, clear solution (no presence of visible lumps or phase separation) was obtained. Components 8 and 9 were added slowly to the solution, and the stirring speed was gradually increased to 2500 rpm. Stirring was continued until a uniform, smooth dispersion (no presence of visible lumps or phase separation) was obtained and the fineness of the grind was at least 5 on the Hegman scale. Stirring was reduced to 300 rpm, and components 10 and 11 were added to the dispersion and blended to form a uniform coating mixture (no presence of visible lumps or phase separation). Thereafter stirring was stopped and the uniform coating mixture was filtered through a 190-micron filter to form to form the Exemplary Liquid Coating Composition #1.

After about 24 hours, the Exemplary Liquid Coating Composition #1 was stirred and Stormer viscosity thereof was measured via ASTM D 562. The Stormer viscosity for Exemplary Liquid Coating Composition #1 was about 95 KU.

### Example 2: Preparation of Exemplary of Liquid Coating Composition #2 and Viscosity Measurement

As shown in Table 2 below, Exemplary Liquid Coating Composition #2 included components 1-10.

TABLE 2
Exemplary Liquid Coating Composition #2

| Component | Component | | Mass |
|---|---|---|---|
| # | class | Material | (g) |
| 1 | Water | Water (here, from Market Basket) | 90 |
| 2 | Dispersant | Sodium salt of poly(acrylic) | 2.55 |
| | | acid (here, Tamol 945 from | |
| | | Dow Chemicals) | |
| 3 | Surfactant | Nonionic surfactant (here, | 0.616 |
| | | Tergitol NP-9 from Sigma- | |
| | | Aldrich) | |
| 4 | Defoamer | VOC-free silicone-containing | 0.15 |
| | | defoamer (here, BYK 024 from | |
| | | BYK-Chemie GmbH) | |
| 5 | Rheology | Hydroxyethylcellulose (here, | 1.2 |
| | Modifier | Natrosol 250HR from Ashland, | |
| | | Inc.) | |
| 6 | pH | Ammonium Hydroxide (here, from | 0.1 |
| | Modifier | Sigma-Aldrich) | |
| 7 | Pigment | Titanium Dioxide (here, RCL 595 | 41.9 |
| | | from Ineos Group) | |
| 8 | Desiccant | Silica Gel (here, SYLOID AL1 | 56.423 |
| | | from Grace and Co.) | |
| 9 | Binder | Acrylic Binder (here, Rhoplex | 79 |
| | latex | 101 from Dow Chemicals) | |
| 10 | Coalescent | Ester Alcohol (here, Texanol | 1.26 |
| | | ester alcohol from Eastman | |
| | | Chemical Co.) | |

The method of making Exemplary Liquid Coating Composition #2 included the following steps: Components 1-4 were weighed into a 250 mL plastic beaker and stirred at 300 rpm with a 5 cm diameter dispersion blade to form a first mixture. Component 5 was added to the first mixture and thoroughly dispersed to form a second mixture. Component 6 was added dropwise to the second mixture until the pH reached a value of 8 to form a third mixture. Stirring continued until all of component 5 was dissolved and a uniform, clear solution (no presence of visible lumps or phase separation) was obtained. Components 7 and 8 were added slowly to the solution, and the stirring speed was gradually increased to 2500 rpm. Stirring was continued until a uniform, smooth dispersion (no presence of visible lumps or phase separation) was obtained and the fineness of the grind was at least 5 on the Hegman scale. Stirring was reduced to 300 rpm, and components 9 and 10 were added to the dispersion and blended to form a uniform coating mixture (no presence of visible lumps or phase separation). Thereafter, stirring was stopped and the uniform coating mixture was filtered through a 190-micron filter to form Exemplary Liquid Coating Composition #2.

After about 24 hours, the Exemplary Liquid Coating Composition #2 was stirred and Stormer viscosity thereof was measured via ASTM D 562. The Stormer viscosity Exemplary Liquid Coating Composition #2 was about 95 KU.

### Example 3: Preparation of Exemplary of Liquid Coating Composition #3

As shown in Table 3 below, Exemplary Liquid Coating Composition #3 included components 1-10.

TABLE 3
Exemplary Liquid Coating Composition #3

| Component | Component | | Mass |
|---|---|---|---|
| # | class | Material | (g) |
| 1 | Water | Water (here, from Market Basket) | 90.752 |
| 2 | Dispersant | Sodium salt of poly(acrylic) acid | 3.552 |
| | | (here, Tamol 945 from Dow | |
| | | Chemicals) | |
| 3 | Surfactant | linear non-ionic surfactant | 0.704 |
| | | (here, Tergitol 15-S-9 from | |
| | | Sigma-Aldrich) | |
| 4 | Defoamer | Defoamer (here, Foamaster MO | 0.352 |
| | | NXZ NC from BASF) | |
| 5 | Rheology | Hydroxyethylcellulose (here, | 0.832 |
| | Modifier | Natrosol 250HR from Ashland, | |
| | | Inc.) | |
| 6 | pH | Ammonium Hydroxide (here, from | 0.1 |
| | Modifier | Sigma-Aldrich) | |
| 7 | Pigment | Titanium Dioxide (here, RCL 595 | 78.208 |
| | | from Ineos Group) | |
| 8 | Desiccant | Silica Gel (here, SYLOID AL1 | 78.208 |
| | | from Grace and Co.) | |
| 9 | Binder | vinyl acrylic copolymer emulsion | 65.632 |
| | latex | (here, Rovace 9100 AF from Dow | |
| | | Chemicals) | |
| 10 | Coalescent | VOC-free coalescent (here, EPS | 1.76 |
| | | 9147 from EPS Technologies | |

The method of making Exemplary Liquid Coating Composition #3 included the following steps: Components 1-4 were weighed into a 250 mL plastic beaker and stirred at 300 rpm with a 5 cm diameter dispersion blade to form a first mixture. Component 5 was added to the first mixture and thoroughly dispersed to form a second mixture. Component 6 was added dropwise to the second mixture until the pH reached a value of 8 to form a third mixture. Stirring continued until all of component 5 was dissolved and a uniform, translucent mixture (no presence of visible lumps or phase separation) was obtained. Components 7 and 8 were added slowly to the solution, and the stirring speed was gradually increased to 2500 rpm. Stirring was continued until a uniform, smooth dispersion (no presence of visible lumps or phase separation) was obtained and the fineness of the grind was at least 5 on the Hegman scale. Stirring was reduced to 300 rpm, and components 9 and 10 were added and blended to form a uniform coating mixture (no presence of visible lumps or phase separation). Thereafter stirring was stopped and the uniform coating mixture was filtered through a 190-micron filter to form to form the Exemplary Liquid Coating Composition #3.

After about 24 hours, the Exemplary Liquid Coating Composition #3 was stirred and Stormer viscosity thereof was measured via ASTM D 562. The Stormer viscosity of Exemplary Liquid Coating Composition #3 was about 92 KU.

### Example 4: Preparation of Exemplary of Liquid Coating Composition #4 and Viscosity Measurement

As shown in Table 4 below, Exemplary Liquid Coating Composition #4 included components 1-10.

TABLE 4
Exemplary Liquid Coating Composition #4

| Component | Component | | Mass |
|---|---|---|---|
| # | Class | Material | (g) |
| 1 | Water | Water (here, from Market Basket) | 90.752 |
| 2 | Dispersant | Sodium salt of poly(acrylic) acid | 3.552 |
| | | (here, Tamol 945 from Dow | |
| | | Chemicals) | |
| 3 | Surfactant | linear non-ionic surfactant (here, | 0.704 |
| | | Tergitol 15-S-9 from Sigma- | |
| | | Aldrich) | |
| 4 | Defoamer | Defoamer (here, Foamaster MO | 0.352 |
| | | NXZ NC from BASF) | |
| 5 | Rheology | Hydroxyethylcellulose (here, | 0.832 |
| | Modifier | Natrosol 250HR from Ashland, | |
| | | Inc.) | |
| 6 | pH | Ammonium Hydroxide (here, | 0.1 |
| | Modifier | from Sigma-Aldrich) | |
| 7 | Pigment | Titanium Dioxide (here, RCL 595 | 78.208 |
| | | from Ineos Group) | |
| 8 | Desiccant | Silica Gel (here, SYLOID AL1 | 78.208 |
| | | from Grace and Co.) | |
| 9 | Binder | Vinyl acrylic (here, Encor 310 | 65.632 |
| | latex | frin Dow Chemicals) | |
| 10 | Coalescent | VOC-free coalescent (here, EPS | 1.76 |
| | | 9147 from EPS Technologies) | |

The method of making Exemplary Liquid Composition #4 included the following steps: Components 1-4 were weighed into a 250 mL plastic beaker and stirred at 300 rpm with a 5 cm diameter dispersion blade to form a first mixture. Component 5 was added to the first mixture and thoroughly dispersed to form a second mixture. Component 6 was added dropwise to the second mixture until the pH reached a value of 8 to form a third mixture. Stirring was continued until all of component 5 was dissolved and a uniform, translucent solution (no presence of visible lumps or phase separation) was obtained. Components 7 and 8 were added slowly to the solution, and the stirring speed was gradually increased to 2500 rpm. Stirring continued until a uniform, smooth dispersion (no presence of visible lumps or phase separation) was obtained and the fineness of the grind was at least 5 on the Hegman scale. Stirring was reduced to 300 rpm, and components 9 and 10 were added to the dispersion and blended to form a uniform coating mixture (no presence of visible lumps or phase separation). Thereafter, stirring was stopped and the uniform coating mixture was filtered through a 190-micron filter to form the Exemplary Liquid Coating Composition #4.

After about 24 hours, the Exemplary Liquid Coating Composition #4 was stirred and Stormer viscosity thereof was measured via ASTM D 562. The Stormer viscosity for Exemplary Liquid Coating Composition #4 was about 92 KU.

### Example 5: Preparation of Exemplary of Liquid Coating Composition #5 and Viscosity Measurement

As shown in Table 5 below, Exemplary Liquid Coating Composition #2 included components 1-9.

TABLE 5
Exemplary Liquid Coating Composition #5

| Component | Component | | Mass |
|---|---|---|---|
| # | class | Material | (g) |
| 1 | Water | Water (here, from Market Basket) | 108 |
| 2 | Dispersant | Sodium salt of poly(acrylic) acid | 2.76 |
| | | (here, Tamol 945 from Dow | |
| | | Chemicals) | |
| 3 | Defoamer | Defoamer (here, Foamaster MO | 0.29 |
| | | NXZ NC from BASF) | |
| 4 | Pigment | Titanium Dioxide (here, RCL 595 | 50.65 |
| | | from Ineos Group) | |
| 5 | Desiccant | Silica Gel (here, SYLOID AL1 | 69.35 |
| | | from Grace and Co.) | |
| 6 | pH | 2-Amino-2-methyl-1-propanol | 5.5 |
| | Modifier | (here AMP-95 from Advancion | |
| | | Corporation) | |
| 7 | Binder | all-acrylic polymer emulsion (here, | 79.26 |
| | latex | Acronal PLUS 4230 from BASF) | |
| 8 | Coalescent | VOC-free coalescent (here, EPS | 1.36 |
| | | 9147 from EPS Technologies | |
| 9 | Rheology | HASE, Hydrophobically modified | 3.25 |
| | Modifier | Alkali Swellable Emulsion (here, | |
| | | Acrysol DR-73 from Dow | |
| | | Chemicals) | |

The method of making Exemplary Liquid Coating Composition #5 included the following steps: Components 1-3 were weighed into a 250 mL plastic beaker and stirred at 300 rpm with a 5 cm diameter dispersion blade to form a first mixture. Components 4 and 5 were added slowly to the first mixture to form a second mixture, and the stirring speed was gradually increased to 2500 rpm. Stirring continued until a uniform, smooth dispersion (no presence of visible lumps or phase separation) was obtained and the fineness of the grind was at least 5 on the Hegman scale. Stirring was reduced to 300 rpm, and component 6 was added slowly to the dispersion until the pH reached a value of 8.7. While stirring continued, components 7 and 8 were then added and blended, followed by the slow addition of component 9. After about 1 hr of additional stirring, a uniform coating mixture was obtained. Thereafter, stirring was stopped and the uniform coating mixture was filtered through a 190-micron filter to form to form the Exemplary Liquid Coating Composition #5.

After about 24 hours, the Exemplary Liquid Coating Composition #5 was stirred and the Stormer viscosity thereof was measured via ASTM D 562. The Stormer viscosity for Exemplary Liquid Coating Composition #5 was between about 100 KU-110 KU.

### Example 6: Performance Testing

Exemplary Liquid Coating Composition #1 as prepared in example 1 was tested according to the following procedures described below in Table 6.

TABLE 6
Testing of Exemplary Liquid Coating Composition #1

| Property | Test | Description |
|---|---|---|
| Color | ASTM D 2244 | Liquid coating composition is applied to a sealed |
| | | white chart at 6 wet mils and dried overnight. The |
| | | color is measured using illuminant D65/10 degree |
| | | observer CIEL*a*b* color space on a Konica |
| | | Minolta CM-3700A D/8 degree (sphere) |
| | | spectrophotometer. |
| Y-Reflectance | ASTM D 2244 | Liquid coating composition is applied to a sealed |
| | | white chart at 6 wet mils and dried overnight. The |
| | | Y- reflectance is measured using illuminant |
| | | D65/10 degree observer CIEL*a*b* color space on |
| | | a Konica Minolta CM-3700A D/8 degree (sphere) |
| | | spectrophotometer. |
| Gloss | ASTM D 523 | Liquid coating composition is applied to a sealed |
| | | white chart at 6 wet mils and dried overnight. A |
| | | BYK micro-TRI-gloss unit is used. Results are an |
| | | average from 3 readings on a 3 by 6 in area of the |
| | | test specimen. |
| Contrast | ASTM D 2805 | Liquid coating composition is applied to an opacity |
| Ratio | | chart using an 8/5 split bird bar. The opacity is |
| | | measured using illuminant D65/10 degree observer |
| | | CIEL*a*b* color space on a Konica Minolta CM- |
| | | 3700A D/8 degree (sphere) spectrophotometer. |
| Adhesion | ASTM D 3359 | Liquid coating composition is applied to an |
| | | aluminum panel at 6 wet mils and dried for |
| | | overnight and one week. Method B, crosscut, is |
| | | used. Intertape Polymer Group 51596 Polyester |
| | | Film/Polyester Non-Woven Tape is applied over |
| | | the cut and pulled to remove paint. An average of |
| | | 3 tests is rated 5 to 0 (5 = no loss of adhesion 0 = |
| | | significant to complete loss of adhesion). |
| Scrub Test | ASTM D 2486 | Liquid coating composition is applied to a scrub |
| | | chart with a 7 mil Dow bar and dried for one week. |
| | | The panel is secured to a Gardco D10 washability |
| | | machine and scrubbed with a bristle brush and |
| | | abrasive material until the film (dried coating |
| | | composition) is removed from the panel in a |
| | | continuous line across the shim. Average of two |
| | | shims can be reported. A control paint, Sherwin |
| | | Williams Emerald Interior, was run simultaneously. |
| Washability | CRGI TM 79 | Liquid coating composition is applied to a black |
| | | plastic scrub chart at 7 wet mils and air dried 1 |
| | | week. After 1 week, stains are applied and left on |
| | | the panel for one hour. After 1 hour, stains are |
| | | gently wiped off and rinsed with tap water. Panel |
| | | is placed on a washability machine and washed |
| | | with a sponge and specified cleaner for 100 cycles. |
| | | Once complete panel is dried at ambient conditions |
| | | overnight. The next day panel is rated visually on |
| | | a scale of 0 to 10 (0 = poor, 10 = excellent.) Panel can |
| | | also be read for color difference between stained |
| | | portion and unstained portion on a spectrophotometer. |
| Package | ASTM D 1849 | Physical coat properties are evaluated after oven |
| Stability | | aging. Samples of liquid coating compositions are |
| | | put into an oven at 120 degrees Fahrenheit. |
| | | Viscosity measurements are taken and compared to |
| | | the original measurements. Samples are evaluated |
| | | for visual defects such as syneresis, settling, and |
| | | skinning. This test is normally run for 2-4 weeks. |
| KU Viscosity | ASTM D 562 | A Byko-visc DS viscometer is used. The test |
| | | method covers the measurement of Krebs |
| | | Unit(KU) viscosity to evaluate the in can |
| | | consistency of the liquid coating composition. |
| | | Average of two readings reported. |

The testing results of Exemplary Liquid Coating Composition #1 are shown below in Tables 7-10. In accordance with Table 6, for each test except for KU Viscosity, the Exemplary Liquid Coating Composition #1 was dried into a respective exemplary dried coating composition, thereby forming a respective film, and thus the testing results reflect that of such films.

TABLE 7
Results of Color, Y-Reflectance and Gloss Testing

| | |
|---|---|
| Color | Gloss |

| L | a | b | Y-Reflectance | 20° | 60° | 85° |
|---|---|---|---|---|---|---|
| 97.32 | −0.49 | 1.93 | 93.23 | 1.4 | 2.6 | 6.3 |

TABLE 8
Results of Contrast Ration, Tape Adhesion
and Scrub Resistance Testing

| | | |
|---|---|---|
| Contrast Ratio | Tape Adhesion | Scrub |

| 2.5 mils | 4.0 mils | 2.5 mils | 4 mils | Resistance |
|---|---|---|---|---|
| 96.16 | 98.29 | 5B | 4.3B | 169 |

TABLE 9
Results of Washability Testing

| | Red | | | | | |
|---|---|---|---|---|---|---|
| | Washable | | Blue | Black | | |
| Property | Marker | Pencil | pen | Sharpie | Ketchup | Mustard |
| Washability | 7 | 5 | 1 | 1 | 9 | 5 |
| (Rating) | | | | | | |
| Washability | 4.29 | 10.53 | 23.82 | 52.82 | 1.23 | 8.06 |
| (DE) | | | | | | |

TABLE 10
Results of Stability Testing

| | 2 Weeks | | 4 Weeks | |
|---|---|---|---|---|
| Initial KU | KU | Comments | KU | Comments |

| | | | | |
|---|---|---|---|---|
| Stability | 90.4 | 106.9 | No Settling. | No Settling. |
| | | | No Skinning. | No Skinning. |
| | | | No Syneresis. | No Syneresis. |

The foregoing test results of the film formed from the Exemplary Liquid Coating Composition #1 of example 1 illustrate that the Exemplary Liquid Coating Composition #1 can be suitable for use as a paint, e.g., paint for a wall or ceiling of building or part of a building.

### Example 6: Humidity Buffering Properties

The liquid coating compositions described herein can have humidity buffering properties that make it suitable for regulating the climate inside a building or portion of a building. One property is the moisture storage capacity of a film, where the film includes one or more dried coating compositions (the one or more dried coating compositions formed from one or more liquid coating compositions described herein). The moisture storage capacity is the maximum quantity of moisture or water vapor that the film can adsorb, measured as a percentage of the dry film weight (the weight of the film with no water). Another characteristic is the moisture adsorption isotherm, which is the relationship between the moisture content and the relative humidity as the relative humidity is slowly increased from the dry state. A related characteristic is the desorption isotherm, which is the relationship between the moisture content and the relative humidity as the relative humidity is slowly decreased from the saturated state. Most materials have a lower moisture content at a particular relative humidity upon humidification than upon drying, and this difference in moisture content which depends on the prior state is called hysteresis.

The moisture storage capacity, the moisture adsorption isotherm, and the moisture desorption isotherm for the following samples were measured:
Exemplary Liquid Coating Composition #1 as prepared in example 1
Exemplary Liquid Coating Composition #2 as prepared in example 2
Exemplary Liquid Coating Composition #3 as prepared in example 3
Exemplary Liquid Coating Composition #5 as prepared in example 5
Conventional Control Paint #1 (Behr Interior Ceiling Flat Paint, Ultra Pure White #558)
Conventional Control Paint #2 (Sherwin Williams Emerald® Ceiling Flat Paint #558)
Conventional Control Paint #3 (Benjamin Moore Aura® Bath & Spa Matte #532)
Conventional Control Paint #4 (Benjamin Moore Ben® Semi-Gloss F627)

Prior to testing, each sample was applied to a thin aluminum sheet substrate (whose weight was measured prior to coating) and dried by heating it to 200° F. in a ventilated drying oven for a minimum of 3 hours to form a film and then weighed. The film was then be placed in a chamber with a fixed relative humidity that was maintained by a saturated solution and left to equilibrate for at least 48 hours. Saturated solutions of lithium chloride, magnesium chloride, magnesium nitrate, sodium chloride, and potassium nitrate were used to maintain the relative humidity inside sealed containers at 11%, 33%, 54%, 75%, and 94%, respectively, at room temperature.

To measure the moisture storage capacity for each sample, the corresponding film and its substrate were placed directly in a sealed container at 94% RH and room temperature, left to equilibrate for at least 3 days, and then weighed. The weight of the aluminum substrate was subtracted from the total to find the weight of the film.

To measure the moisture adsorption isotherm for each sample, the corresponding film and its substrate were equilibrated and then weighed in environments with increasing humidity levels.

To measure the moisture desorption isotherm for each sample, an initially saturated corresponding film and its substrate were equilibrated in environments with progressively decreasing humidity and weighed after each equilibration step.

The moisture storage capacity measurements for the films formed from Exemplary Liquid Coating Compositions #1, #2, #3, and #5 are shown and compared with results from the films formed from Conventional Control Paints in Table 11 below.

TABLE 11
Results of Moisture Storage Capacity Testing

| | Moisture Storage |
|---|---|
| | Capacity (% of dry |
| Samples | weight of the film) |
| Exemplary Liquid Coating Composition #1 | 15.0 |
| Exemplary Liquid Coating Composition #2 | 13.1 |
| Exemplary Liquid Coating Composition #3 | 12.1 |
| Exemplary Liquid Coating Composition #5 | 13.8 |
| Conventional Control Paint #1 (Behr Interior | 2.5 |
| Ceiling Flat Paint, Ultra Pure White #558) | |
| Conventional Control Paint #2 (Sherwin | 1.7 |
| Williams Emerald ® Ceiling Flat Paint #558) | |
| Conventional Control Paint #3 (Benjamin | 2.5 |
| Moore Aura ® Bath & Spa Matte #532) | |
| Conventional Control Paint #4 (Benjamin | 3.1 |
| Moore Ben ® Semi-Gloss F627) | |

As shown in Table 11, the sample films formed from the Exemplary Liquid Coating Compositions had a moisture storage capacity of about 12.1 wt. % to 15 wt %, while the moisture storage capacity of the films formed from the conventional paints were only about 1.7 wt. % to 3.1 wt. %. The results shown in Table 11 indicate that the films formed from the Exemplary Liquid Coating Compositions absorbed significantly more moisture than the films formed from the conventional paints.

The moisture adsorption/desorption isotherm measurements of the film formed from Exemplary Liquid Coating Composition #1 are shown in the Table 12 below. The same film was used in each humidity environment.

TABLE 12
Results of Moisture Adsorption/Desorption Isotherm Measurements

| | |
|---|---|
| Relative | Moisture Content (% of dry weight) |

| Humidity (%) | Adsorption | Desorption |
|---|---|---|
| 0 | 0 | 1.0 |
| 11 | 0.8 | 2.2 |
| 34 | 3.9 | 5.5 |
| 54 | 8.0 | 9.8 |
| 75 | 12 | 12 |
| 94 | 15 | 15 |

As shown in Table 12, the moisture content of the film was about 0.8% at 11% relative humidity, about 3.9% at 34% relative humidity, about 8.0% at 54% relative humidity, about 12% at 75% relative humidity, and about 15% at 94% relative humidity. The capacity of the film to adsorb water in the relative humidity range 34% to 75% was 8.1% of its dry weight, providing a large capacity to regulate humidity in the optimal range for human comfort. The total moisture storage capacity is at least about 15%. It should be noted that moisture storage capacity is the maximum quantity of water that the film can adsorb from the environment as a fraction of its dry weight at a relative humidity of 100%.

As further shown in Table 12, the adsorption isotherm for the film was approximately linear in the relative humidity range of 0% to 94%. The moisture desorption isotherm was also approximately linear. The isotherms of the film showed little hysteresis, and the difference between the adsorption and desorption isotherms was less than 2% at every value of the relative humidity.

The moisture adsorption/desorption isotherm measurements of the film formed from Exemplary Liquid Coating Composition #2 are shown in the Table 13 below.

TABLE 13
Results of Moisture Adsorption/Desorption Isotherm Measurements

| | |
|---|---|
| Relative | Moisture Content (% of dry weight) |

| Humidity (%) | Adsorption | Desorption |
|---|---|---|
| 0 | 0 | 0 |
| 11 | 2.2 | 2.2 |
| 34 | 4.2 | 4.0 |
| 54 | 7.5 | 7.4 |
| 75 | 10.2 | 10.3 |
| 94 | 13.1 | 13.1 |

As shown in Table 13, the adsorption isotherm for the film was approximately linear in the relative humidity range of 0% to 94%. The moisture desorption isotherm was also approximately linear. The isotherms of the film showed little hysteresis, and the difference between the adsorption and desorption isotherms was no greater than 0.2% of the dry weight at every value of the relative humidity.

The moisture adsorption/desorption isotherm measurements of the film formed from Exemplary Liquid Coating Composition #5 are shown in the Table 14 below.

TABLE 14
Results of Moisture Adsorption/Desorption Isotherm Measurements

| | |
|---|---|
| Relative | Moisture Content (% of dry weight) |

| Humidity (%) | Adsorption | Desorption |
|---|---|---|
| 0 | 0 | 0 |
| 11 | 1.4 | 1.8 |
| 34 | 2.5 | 2.7 |
| 54 | 4.3 | 4.3 |
| 75 | 7.2 | 7.6 |
| 94 | 13.8 | 13.8 |

As shown in Table 14, the moisture content of the film was about 1.4% at a 11% relative humidity, about 2.5% at 34% relative humidity, about 4.3% at 54% relative humidity, about 7.2% at 75% relative humidity, and about 13.8% at 94% relative humidity. The capacity of the film to adsorb water in the relative humidity range 75% to 94% was 6.6% of its dry weight, providing a large capacity to regulate humidity and prevent condensation in the range where fungal growth can occur. The total moisture storage capacity was at least about 13.8%. It should be noted that moisture storage capacity is the maximum quantity of water that the film can adsorb from the environment as a fraction of its dry weight at a relative humidity of 100%.

As shown in Table 14, the adsorption isotherm for the film was approximately linear in the relative humidity range of 0% to 94%. The moisture desorption isotherm was also approximately linear. The isotherms of the film formed from Exemplary Liquid Coating Composition #5 showed little hysteresis, and the difference between the adsorption and desorption isotherms was less than 0.5% of the dry weight at every value of the relative humidity.

For comparison, the moisture adsorption isotherm measurements of the film formed from commercially available Conventional Control Paint #1 (Behr Interior Ceiling Flat Paint, Ultra Pure White #558) is provided in Table 15 below.

TABLE 15
Results of Moisture Adsorption Isotherm Measurement

| | |
|---|---|
| Relative | Moisture Content (% of dry weight) |

| Humidity (%) | Adsorption | Desorption |
|---|---|---|
| 0 | 0 | |
| 11 | 0.1 | N/A |
| 34 | 0.3 | N/A |
| 54 | 0.3 | N/A |
| 75 | 0.3 | N/A |
| 94 | 1.6 | N/A |

As shown in Table 15, the adsorption isotherm for the film rose approximately linearly from 0% moisture content at 0% relative humidity to about 0.3% moisture content at 30% relative humidity, was approximately flat at 0.3% moisture content in the relative humidity range of 30% to 75% and then rose to 1.6% moisture content at 94% relative humidity. The film showed approximately no capacity to regulate humidity in the relative humidity range 30%-75%, and its moisture storage capacity of 1.6% by dry weight was less than one eighth the moisture storage capacity of the films formed from Exemplary Liquid Coating Compositions #1 and #2.

### Example 7: Water Vapor Permeance

The water vapor permeance of film samples formed from one of the following were tested:
Exemplary Liquid Coating Composition #1 as prepared in example 1
Exemplary Liquid Coating Composition #2 as prepared in example 2
Exemplary Liquid Coating Composition #3 as prepared in example 3
Exemplary Liquid Coating Composition #3 as prepared in example 4
Exemplary Liquid Coating Composition #5 as prepared in example 5

To measure the water vapor permeance of each film sample, an exemplary liquid coating composition was applied to Kraft paper and left to dry to form a corresponding film sample before performing a measurement according to ASTM E 96-00 on the coated paper. More specifically, according to ASTM E 96-00, dry cup permeance is measured using an average relative humidity (RH) of 25%, with the RH on one side of the layer at 0% and the RH on the other side at 50% at a temperature of 73° F. (23° C.), and a wet cup permeance is measured using an average RH of 75%, with the RH on one side of the layer at 50% and the RH on the other side at 100% at a temperature of 73° F. (23° C.). The permeance of an uncoated paper substrate was measured separately to be about 200 U.S. perms. The permeance of the film was then determined by treating the permeance of the coated paper as a combination of two layers in series and adding their permeance values accordingly.

The test results for each film sample were as follows:
The film formed from Exemplary Liquid Coating Composition #1 at a dry coat weight of 815 g/m² had a wet cup permeance of 63 U.S. perms.
The film sample formed from Exemplary Liquid Coating Composition #1 with a dry coat weight of 86 g/m² had a wet cup permeance of 352 U.S. perms and a dry cup permeance of 45 U.S. perms.
The film sample formed from Exemplary Liquid Coating Composition #2 with a dry coat weight of 815 g/m² had a wet cup permeance of 63 U.S. perms and a dry cup permeance of 21.6 U.S. perms.
The film sample formed from Exemplary Liquid Coating Composition #2 with a dry coat weight of 210 g/m² had a wet cup permeance of 181 U.S. perms and a dry cup permeance of 52 U.S. perms.
The film sample formed from Exemplary Liquid Coating Composition #3 with a dry coat weight of 107 g/m² had a wet cup permeance of 333 U.S. perms.
The film sample formed from Exemplary Liquid Coating Composition #4 with a dry coat weight of 720 g/m² had a wet cup permeance of 98 U.S. perms and a dry cup permeance of 30 U.S. perms.
The film sample formed from Exemplary Liquid Coating Composition #5 with a dry coat weight of 430 g/m² had a wet cup permeance of 51 U.S. perms and a dry cup permeance of 11.0 U.S. perms.
The film sample formed from Exemplary Liquid Coating Composition #5 with a dry coat weight of 181 g/m² has a wet cup permeance of 74 U.S. perms and a dry cup permeance of 12.7 U.S. perms.
The film sample formed from Exemplary Liquid Coating Composition #5 with a dry coat weight of 87 g/m² had a wet cup permeance of 140 U.S. perms.

### Example: 8: Open Pore Volume

Comparative Examples 1-3 described below demonstrate the advantage of using silica gel with a pore volume from about 0.2 mL/g to about 1.0 mL/. The pore volumes of the silica gel used in the Exemplary Liquid Coating Compositions #1-#5 of Examples 1-5, respectively, and in Comparative Examples 1-2 are shown in the Table 16 below:

TABLE 16
Selection of Silica Gels with Different Pore Volumes for Comparative Testing

| | | Silica Gel (here, | Silica Gel (here, |
|---|---|---|---|
| | Silica Gel (here, SYLOID | Syloid 807 from | Syloid 244 from |
| Desiccant | AL1 from Grace and Co.) | Grace and Co.) | Grace and Co.) |
| Pore volume, mL/g | 0.4 | 2 | 1.6 |
| Compositions using | Exemplary Liquid | Comparative | Comparative |
| this desiccant | Coating Compositions #1-#5 | Examples #1 and #2 | Example #3 |

Comparative Example #1 shown in Table 17 below was an attempt to prepare a paint formulation with the same component ratios as in Exemplary Liquid Coating Composition #1 but with Syloid 807 as the desiccant instead of Syloid AL-1.

TABLE 17
Comparative Example #1

| Component | Component | | Mass |
|---|---|---|---|
| # | class | Material | (g) |
| 1 | Water | Water (here, from Market | 73 |
| | | Basket) | |
| 2 | Solvent | Propylene Glycol (here, | 24 |
| | | from Sigma-Aldrich) | |
| 3 | Dispersant | Sodium neutralized | 3 |
| | | polyacrylate dispersing | |
| | | agent (here, Ecodis p 50 | |
| | | from Arkema USA, Inc) | |
| 4 | Surfactant | Nonionic surfactant | 0.616 |
| | | (here, Tergitol NP-9 from | |
| | | Sigma-Aldrich) | |
| 5 | Defoamer | oil-hydrophobic silica | 0.15 |
| | | blend (here, Rhodoline | |
| | | 622 from Solvay USA, Inc.) | |
| 6 | Rheology | Hydroxyethylcellulose | 1.2 |
| | Modifier | (here, Natrosol 250HR | |
| | | from Ashland, Inc.) | |
| 7 | pH Modifier | Ammonium Hydroxide | 0.1 |
| | | (here, from Sigma-Aldrich) | |
| 8 | Pigment | Titanium Dioxide (here, | 41.9 |
| | | RCL 595 from Ineos Group) | |
| 9 | Desiccant | Silica Gel (here, Syloid | 69.6 |
| | | 807 from Grace and Co.) | |
| 10 | Binder | Acrylic latex (here, | 58.5 |
| | latex | NEOCAR Acrylic 820 | |
| | | from Arkema USA, Inc.) | |
| 11 | Coalescent | Glycol Either (here, | 1.26 |
| | | Glycol Ether DB8 from | |
| | | Sigma-Aldrich) | |

As shown in Table 17 above, Comparative Example #1 included components 1-11, each present in the composition with a mass as shown. The components 1-11 were weighed and mixed according to the following steps: Components 1-5 were weighed into a 250 mL plastic beaker and stirred at 300 rpm with a 5 cm diameter dispersion blade. Component 6 was added and thoroughly dispersed. Component 7 was added dropwise until the pH reached a value of 8. The composition was stirred until all of component 6 was dissolved and a uniform, translucent mixture was obtained. Component 8 was added slowly, and the stirring speed was gradually increased to 2500 rpm. Component 9 was added slowly. After the addition of about 20 g of Component 9, the mixture formed a gel, which no longer flowed.

Alternatively, the components of Comparative Example #1, as listed in Table 17, were mixed in a sequence that delayed the addition of the rheology modifier until the end to prevent gel formation. The components were weighed and mixed according to the following steps: Components 1-5 were weighed into a 250 mL plastic beaker and stirred at 300 rpm with a 5 cm diameter dispersion blade. Component 6 was added and thoroughly dispersed. Component 7 was added dropwise until the pH reached a value of 8. The composition was stirred until all of component 6 was dissolved and a uniform, translucent mixture was obtained. Component 8 was added slowly, and the stirring speed was gradually increased to 2500 rpm. Component 9 was added slowly. After adding about 30 g of Component 9, the mixture formed a gel, which could no longer be processed.

Comparative Example #1 shows that it was not possible to prepare paint with the same desiccant loading as Exemplary Liquid Coating Composition #1 using Syloid 807 silica gel, which has a pore volume of 2 mL/g.

Comparative Example #2 shown in Table 18 below was an attempt to prepare a paint formulation with a composition similar to Comparative Example #1 but with a reduced amount of Syloid 807 silica gel desiccant.

TABLE 18
Comparative Example #2

| Component | Component | | Mass |
|---|---|---|---|
| # | class | Trade Name | (g) |
| 1 | Water | Water (here, from Market | 73 |
| | | Basket) | |
| 2 | Solvent | Propylene Glycol (here, | 24 |
| | | from Sigma-Aldrich) | |
| 3 | Dispersant | Sodium neutralized | 3 |
| | | polyacrylate dispersing | |
| | | agent (here, Ecodis p 50 | |
| | | from Arkema USA, Inc) | |
| 4 | Surfactant | Nonionic surfactant (here, | 0.616 |
| | | Tergitol NP-9 from | |
| | | Sigma-Aldrich) | |
| 5 | Defoamer | oil-hydrophobic silica | 0.15 |
| | | blend (here, Rhodoline | |
| | | 622 from Solvay USA, Inc.) | |
| 6 | Rheology | Hydroxyethylcellulose | 1.2 |
| | Modifier | (here, Natrosol 250HR | |
| | | from Ashland, Inc.) | |
| 7 | pH Modifier | Ammonium Hydroxide | 0.1 |
| | | (here, from Sigma-Aldrich) | |
| 8 | Pigment | Titanium Dioxide (here, | 41.9 |
| | | RCL 595 from Ineos Group) | |
| 9 | Desiccant | Silica Gel (here, Syloid | 69.6 |
| | | 807 from Grace and Co.) | |
| 10 | Binder latex | Acrylic latex (here, | 58.5 |
| | | NEOCAR Acrylic 820 | |
| | | from Arkema USA, Inc.) | |
| 11 | Coalescent | Glycol Either (here, | 1.26 |
| | | Glycol Ether DB8 from | |
| | | Sigma-Aldrich) | |

As shown in Table 18 above, Comparative Example #2 included components 1-11, each present in the composition with a mass as shown. The components 1-11 were weighed and mixed according to the following steps: Components 1-5 were weighed into a 250 mL plastic beaker and stirred at 300 rpm with a 5 cm diameter dispersion blade. Component 6 was added and thoroughly dispersed. Component 7 was added dropwise until the pH reached a value of 8. The composition was stirred until all of component 6 was dissolved and a uniform, translucent mixture was obtained. Components 8 and 9 were added slowly, and the stirring speed was gradually increased to 2500 rpm. Stirring was continued until a uniform, smooth dispersion was obtained and the fineness of the grind was at least 5 on the Hegman scale. Stirring was reduced to 300 rpm, and components 10 and 11 were added and blended. After a uniform paint mixture was obtained, stirring was stopped and the paint was filtered through a 190-micron paint filter. After about 24 hrs, the paint was gently stirred. After standing overnight in a sealed container at room temperature, Comparative Example #2 formed gel.

Comparative Example #2 shows that even a significantly reduced fractional amount of Syloid 807 silica gel in Exemplary Liquid Coating Composition #1 does not achieve a free-flowing and stable mixture.

Comparative Example #3 shows an attempt to prepare a paint formulation with the same component ratios as in Exemplary Liquid Coating Composition #3 but with Syloid 244 as the desiccant instead of Syloid AL-1.

TABLE 19
Comparative Example #3

| Component | Component | | Mass |
|---|---|---|---|
| # | class | Trade name | (g) |
| 1 | Water | Water (here, from Market Basket) | 90.75 |
| 2 | Dispersant | Sodium salt of poly(acrylic) | 3.55 |
| | | acid (here, Tamol 945 from | |
| | | Dow Chemicals) | |
| 3 | Surfactant | linear non-ionic surfactant | 0.70 |
| | | (here, Tergitol 15-S-9 from | |
| | | Sigma-Aldrich) | |
| 4 | Defoamer | Defoamer (here, Foamaster | 0.35 |
| | | MO NXZ NC from BASF) | |
| 5 | Rheology | Hydroxyethylcellulose | 0.83 |
| | Modifier | powder (here, Natrosol | |
| | | 250HR from Ashland, Inc.) | |
| 6 | pH | Ammonium Hydroxide (here, | 0.1 |
| | Modifier | from Sigma-Aldrich) | |
| 7 | Pigment | Titanium Dioxide (here, | 78.21 |
| | | RCL 595 from Ineos Group) | |
| 8 | Desiccant | Silica Gel (here, Syloid | 78.21 |
| | | 244 from Grace and Co.) | |
| 9 | Binder | vinyl acrylic copolymer | 65.63 |
| | latex | emulsion (here, Rovace | |
| | | 9100 AF from Dow Chemicals) | |
| 10 | Coalescent | VOC-free coalescent (here, | 1.76 |
| | | EPS 9147 from EPS Technologies | |

As shown in Table 19 above, Comparative Paint Composition #3 can include components 1-10, which can each have a mass relative to one another as shown. The components 1-10 can be weighed and mixed according to a variety of methodologies described herein. By way of a non-limiting example, a method of making Comparative Paint Composition #3 can include the following steps: In some aspects, components 1-4 can be weighed into a 250 mL plastic beaker and stirred at 300 rpm with a 5 cm diameter dispersion blade. Components 7 can be added slowly, and the stirring speed can be gradually increased to 2500 rpm. Component 9 was added slowly. After the addition of about 46 g, the mixture formed a gel.

Comparative Example #3 shows that it is impossible to prepare paint with the same desiccant loading as in Exemplary Liquid Coating Composition #1 with Syloid 244 silica gel, which has a pore volume of 1.6 mL/g.

### Example 9: Leveling and Sag Behavior

One property of a coating composition is leveling. For a smooth coating composition, a high degree of leveling properties is desired, which correlates with a low viscosity measured at low shear rates. For textured paint, a low degree of leveling is desired, which correlates with a higher viscosity measured at low shear rates. Low degree of “sag” or paint dripping beyond the painted area, especially for vertical surfaces, is also desired in all cases. Typically, high leveling correlates with high sag and vice versa. It was found that latexes with large particle sizes, in the range between about 0.2 micrometers to about 0.35 micrometers, provide improved leveling while maintaining low “sag”.

The leveling behavior of Exemplary Liquid Coating Compositions #2, #3 and #4 as prepared in examples 2, 3, and 4, respectively, were evaluated according to ASTM D4062 on the scale from 1 to 10 where 1 is the worst and 10 is the best. Sag of Exemplary Liquid Coating Composition #4 as prepared in example 4 was also evaluated according to ASTM D 4400 on the scale from 4 to 24 where 4 is the worst and 24 is the best. Results are summarized in the Table 20 below:

TABLE 20
Comparison of Leveling and Sag with
Different Latex Particle Sizes

| Exemplary Liquid | | | |
|---|---|---|---|
| Coating | | | |
| Composition | #2 | #3 | #4 |
| Binder Latex | Rhoplex 101 | Rovace | Acronal 4230 |
| | | 9100AF | Plus |
| Latex Particle Size | 120 | 300 | 270 |
| (nm) | | | |
| Leveling | 1 | 5 | 5 |
| (ASTM D 4062) | | | |
| Sag (ASTM D 4400) | N/A | N/A | 24 |

The comparison of paint leveling and sag results presented in Table 16 shows that latexes with a large particle size provide good leveling and good sag resistance.

### Example 10: Climate-Regulating Properties

Test 1: Exemplary Liquid Coating Composition #1 as prepared in Example 1 and Conventional Control Paint #4 (Benjamin Moore Ben® Semi-Gloss F627) were each tested to determine their influence on condensation and humidity, e.g., in a bathroom during a hot shower.

To simulate the conditions in a bathroom during a hot shower and to test the influence of Exemplary Liquid Coating Composition #1 and Conventional Control Paint #4 on condensation and humidity, the following experiment was carried out: One 7″×7″ piece of ½″ gypsum wallboard was coated with the Exemplary Liquid Composition #1 as described herein, while another 7″×7″ piece of ½″ gypsum wallboard was coated with the Conventional Control Paint #4 (Benjamin Moore Regal Select, matte finish, white #548). The coat weight was about 200 g/m² in each case. Two 6″ 5-sided acrylic boxes were brought to equilibrium with the room environment by leaving the top open for at least three hours. The coated gypsum wallboard pieces were also brought to equilibrium with the room environment by leaving the coated surface exposed face up on a table for at least three hours. The boxes were labeled Box 1 and Box 2 and placed next to each other with open sides facing up. A humidity sensor and a 100 mL glass beaker with a 5 cm diameter were placed inside each acrylic box. Water was heated to 150° F. and 50 g and was poured into each beaker. The top of each box was quickly covered by a gypsum wallboard piece with the painted surface facing the inside. Box 1 was covered with the wallboard coated with Exemplary Liquid Coating Composition #1 and Box 2 was covered with the wallboard coated with Conventional Control Paint #4. After 35 minutes, humidity measurements were taken and observations were recorded as set forth below in Table 21.

TABLE 21
Results of Condensation and Humidity Suppression Testing

| | Humidity inside | Visual appearance |
|---|---|---|
| | the box after | of the box after |
| Box | 35 minutes | 35 minutes |
| Box 1 - Exemplary Liquid | 68% | Walls were clear |
| Coating Composition #1 | | |
| Box 2 - Conventional | 80% | Walls were foggy |
| Paint | | from water |
| | | condensation. |

As shown in Table 21, Exemplary Liquid Coating Composition #1 significantly reduced the relative humidity and prevented moisture condensation relative to the conventional paint, which can advantageously inhibit mold growth on the walls.

Test 2: Exemplary Liquid Coating Composition #2 as prepared in Example 2 and Conventional Control Paint #4 (Benjamin Moore Regal Select, matte finish, white #548) were each tested to determine their influence on condensation and humidity, e.g., in a bathroom during a hot shower.

To simulate the conditions in a bathroom during a hot shower and to test the influence of Exemplary Liquid Coating Composition #2 and Conventional Control Paint #4 on condensation and humidity, the following experiment was carried out: The interior walls of and ceiling of one 7.5′ wide×7′ deep×11′ high booth was coated with Exemplary Liquid Coating Composition #2 described herein, while the interior walls and ceiling of another 7.5′ wide×7′ deep×11′ high booth were coated with a Conventional Control Paint #4 (Benjamin Moore Regal Select, matte finish, white #548). The coat weight was about 200 g/m² in each case. The walls painted with Exemplary Liquid Coating Composition #2 had a smooth, crack-free matte white surface with a high aesthetic quality. The walls painted with Conventional Control Paint #4 also had a smooth, crack-free matte white surface with a high aesthetic quality. The two booths were constructed with ½″ gypsum interior walls and ceilings, fiberglass batt insulation between 2″×4″ studs spaced on 16″ centers, and ½″ oriented strandboard exterior sheathing, with a single 60″×80″ sliding glass door in the front wall of each booth. The booths were named Booth 1 and Booth 2 and placed next to each other with the doors open and humidity and temperature (RHT) sensors placed inside.

Humidity measurements were taken about every minute, and observations were recorded before, during, and after the experiment. The two booths were brought to equilibrium with the environment by leaving the sliding doors open for at least one day with fans blowing outside air into the booths. Water was heated to 85° C. in square, 12″ wide buckets using sous-vide cooking appliances. One bucket of heated water was weighed and placed inside Booth 1, after which the door to Booth 1 was closed. Another bucket of heated water was weighed and placed inside Booth 2, after which the door to Booth 2 was closed. After 55 minutes, the buckets of heated water were removed from the booths and weighed, and the doors to the booths were closed again. From the changes in weight of the buckets of heated water, it was determined that the rate of water vapor released from each one was approximately 0.9 kg per hour. The results of the experiment described above for Exemplary Liquid Coating Composition #2 versus Conventional Control Paint #4 are provided below in Table 22.

TABLE 22
Results of Condensation and Humidity Suppression Testing

| | Humidity inside | Observations of the |
|---|---|---|
| | the booth after | booth interior |
| Box | 55 minutes | after 55 minutes |
| Booth 1 - Exemplary | 70% | Walls were dry to the |
| Paint Composition #2 | | touch and the glass |
| | | door was clear. |
| Booth 2 - Conventional | 89% | Walls were wet to the |
| Control Paint #4 | | touch and the glass |
| | | door was foggy from |
| | | water condensation. |

As shown in Table 22, Exemplary Liquid Coating Composition #2 significantly reduced humidity and prevented moisture condensation as compared with Conventional Control Paint #4. In this way, the liquid coating compositions described herein can advantageously inhibit mold growth on the walls.

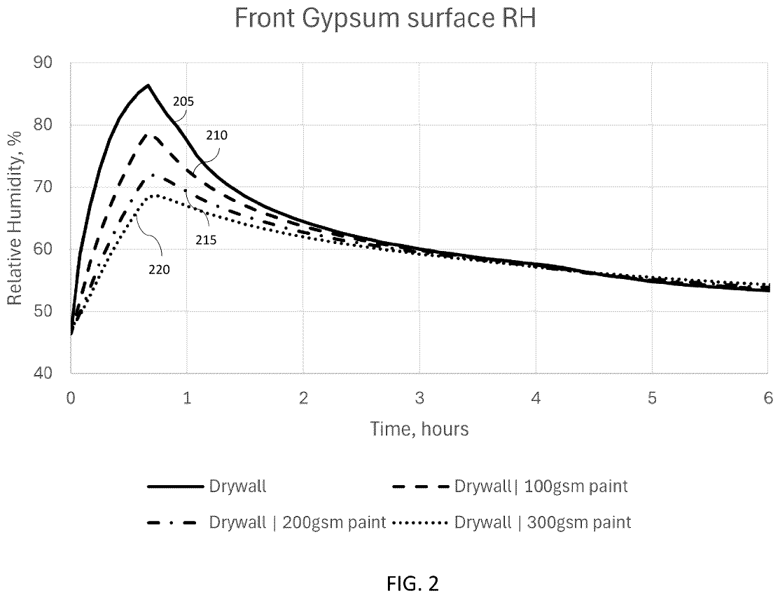

Test 3: To quantify the influence of the climate-present paint formulations on humidity and moisture accumulation in the wall materials behind the paint, the heat and moisture transport that can occur in a bathroom during a hot shower were calculated using the physics simulation software package, WUFI. Buildings with the dimensions and construction materials of the booths described above were modeled in WUFI, assuming a natural ventilation rate of 0.75 air changes per hour (ACH), with coating on the interior surfaces of different coat weights, and equilibrated to an initial relative humidity of 45%. A shower was simulated by introducing a water vapor load of 0.75 kg/hour inside the model booth for 40 minutes. The results of the simulation with no coating (e.g. paint) and with coating layers (paint layers) corresponding to Exemplary Liquid Coating Composition #2 as prepared in Example 2 with coat weights of 100 g/m², 200 g/m², and 300 g/m² are shown in FIG. 2.

FIG. 2 is a graph illustrating the results of WUFI simulations of the relative humidity at a front surface of a gypsum wallboard during a hot shower with different silica gel loadings. As shown in FIG. 2, the WUFI simulations results predict that Exemplary Liquid Coating Composition #2 will significantly reduce the humidity at the front side of the gypsum wallboard relative to conventional paints, which can advantageously inhibit mold growth in the walls. Note that the simulations showed the calculated relative humidity at the front (interior) surface of the gypsum rising during the time the shower produces a vapor load and reaching a peak relative humidity at the end of the shower, after which time the humidity decays back to the equilibrium value over the course of a few hours. The peak humidity in the gypsum decreases with silica gel loading. For example, as shown in FIG. 2, the peak humidity in the gypsum can be about 86% at 0 g/m² silica gel loading, as illustrated by line 205 of the graph. The peak humidity in the gypsum can then be reduced to about 79% at 100 g/m² loading, further reduced to about 72% at 200 g/m² loading and reduced even further to about 69% at 300 g/m² loading, as illustrated by lines 210, 215 and 220, respectively. The last three values, illustrated by lines 210, 215 and 220, respectively, are all below 80%, which can be widely understood to be a threshold beyond which mold grows on wood-based materials.

Terminology used herein is for the purpose of describing particular implementations and implementations only and is not intended to be limiting. For example, as used herein, the singular forms “a,” “an,” and “the” are intended to include the plural forms as well, unless the context clearly indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers can be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. The word “about” or “approximately” when immediately preceding a numerical value means a range of plus or minus 10% of that value, e.g., “about 50” means 45 to 55, “about 25,000” means 22,500 to 27,500, etc. Furthermore, the phrases “less than about” a value or “greater than about” a value should be understood in view of the definition of the term “about” provided herein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative implementations are described above, any of a number of changes can be made to various implementations without departing from the teachings herein. For example, the order in which various described method steps are performed may often be changed in alternative implementations, and in other alternative implementations, one or more method steps may be skipped altogether. Optional features of various structures, methods, and coating composition may be included in some implementations and not in others. Therefore, the foregoing description is provided primarily for exemplary purposes and should not be interpreted to limit the scope of the claims.

The examples and illustrations included herein show, by way of illustration and not of limitation, specific implementations in which the subject matter may be practiced. As mentioned, other implementations may be utilized and derived there from, such that structural and logical substitutions and changes may be made without departing from the scope of this disclosure. Such implementations of the inventive subject matter may be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description. Use of the term “based on,” herein and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with implementations related to the described subject matter. Although a few variations have been described in detail herein, other modifications or additions are possible. In particular, further features and/or variations can be provided in addition to those set forth herein. For example, the implementations described herein can be directed to various combinations and subcombinations of the disclosed features and/or combinations and subcombinations of several further features disclosed herein. In addition, the logic flows depicted in the accompanying figures and/or described herein do not necessarily require the particular order shown, or sequential order, to achieve desirable results. Other implementations may be within the scope of the following claims.

1. A liquid coating composition for decorative paint, comprising:
water, wherein the water is present in the liquid composition in an amount from about 40 wt. % to about 60 wt. %;
a silica gel that reversibly adsorbs and desorbs water, wherein the silica gel comprises a plurality of particles having an average particle size from about 1 micrometer to about 20 micrometers, each particle having a specific surface area from about 400 m²/g to about 900 m²/g, wherein the silica gel is present in the liquid coating composition in an amount from about 10 wt. % to about 30 wt. %, and wherein the silica gel has an open pore volume that is from about 0.2 mL/g to about 1.0 mL/g;
one or more pigments present in the liquid coating composition in a total amount from about 5 wt. % to about 30 wt. %, the one or more pigments comprising titanium dioxide;
a polymeric binder, wherein the polymeric binder is present in the liquid coating composition in an amount from about 45 wt. % to about 25 wt. %, the polymeric binder comprising vinyl acrylic;
one or more rheology modifiers comprising a hydrophobically modified alkali swellable emulsion, a hydroxy ethyl cellulose, or a combination thereof; and
one or more amines;
wherein the liquid coating composition has a Stormer viscosity in the range from about 80 KU to about 120 KU; and
wherein the liquid coating composition has a fineness of grind of Hegman 5 or higher.

2. (canceled)

3. The liquid coating composition of claim 1, wherein the average particle size from of the plurality of particles of the silica gel is from about 5 micrometers to about 10 micrometers.

4. The liquid coating composition of claim 1, wherein the polymeric binder comprises a plurality of particles having an average particle size from about 200 nm to about 350 nm.

5. The liquid coating composition of claim 1, wherein the silica gel is present in the liquid coating composition in an amount from about 158 wt. % to about 25 wt. %.

6. (canceled)

7. The liquid coating composition of claim 1, wherein each particle has a specific surface area from about 500 m²/g to about 900 m²/g.

8. (canceled)

9. The liquid coating composition of claim 1, further comprising:
one or more co-solvents comprising propylene glycol, ethylene glycol, or 2-amino-2-methyl-1-propanol, wherein the one or more co-solvents are present in the liquid coating composition in an amount from about 1 wt. % to about 10 wt. % or from about 0.1 wt. % to about 20 wt. %; and
one or more coalescence promoters comprising polyethylene glycol, polypropylene glycol, esters or ethers of di-, tri-, or poly-ethylene or propylene glycols, or any combination thereof, wherein the one or more coalescence promoters are present in the liquid coating composition in an amount of about 2 wt. % or less.

10. (canceled)

11. The liquid coating composition of claim 1, wherein the one or more pigments further comprise carbon black, iron oxide, phthalocyanine, or any combination thereof.

12-30. (canceled)

31. The liquid coating composition of claim 1, wherein the one or more rheology modifiers are present in the liquid coating composition in an amount from about 0.01 wt. % to about 5 wt. % or from about 0.02 wt. % to about 2 wt. %.

32.-46. (canceled)

47. The liquid coating composition of claim 1, wherein the liquid coating composition has a volatile organic compounds content of below 50 g/L.

48. The liquid coating composition of claim 1, wherein the polymeric binder is present in the liquid coating composition in an amount from about 5 wt. % to about 15 wt. %.

49. A method for controlling moisture and humidity in a building or part of a building, the method comprising:
applying one or more liquid coating compositions of claim 1 to at least a portion of one or more interior surfaces of the building or part of the building; and
allowing the one or more liquid coating compositions to dry on at least the portion of one or more interior surfaces of the building until the one or more liquid coating compositions form a solid film.

50.-53. (canceled)

54. The method of claim 49, wherein applying the one or more liquid coating compositions comprises at least one of:
brushing the one or more liquid coating compositions onto at least a portion of one or more interior surfaces of the building;
spraying the one or more liquid coating compositions onto at least a portion of one or more interior surfaces of the building; or
rolling the one or more liquid coating compositions onto at least a portion of one or more interior surfaces of the building.

55.-56. (canceled)

57. The method of claim 49, wherein the at least a portion of one or more interior surfaces is located in a bathroom of the building.

58. The method of claim 49, wherein the film has a dry coat weight from about 40 g/m² to about 500 g/m².

59-109. (canceled)

110. A method for manufacturing a liquid coating composition for decorative paint, comprising:
combining water, one or more surfactants, one or more dispersants, and one or more defoamer components in a vessel to form a first mixture;
adding at least a portion of one or more amines to the first mixture to form a second mixture;
adding a silica gel and one or more pigments to the second mixture to form a third mixture, the one or more pigments comprising titanium dioxide;
adding one or more pH modifiers to the third mixture to adjust the pH of the third mixture;
adding, the one or more pH modifiers adjust the pH of the third mixture, a polymeric binder to the third mixture, the polymeric binder comprising vinyl acrylic; and
adding, after the polymeric binder is added to the third mixture, one or more rheology modifier to the third mixture and thoroughly dispersing the one or more rheology modifier components in the third mixture, the one of more rheology modifier components comprises a hydrophobically modified alkali swellable emulsion;
wherein the water is present in the liquid coating composition in an amount from about 40 wt. % to about 60 wt. %;
wherein the silica gel is present in the liquid coating composition in an amount from about 10 wt. % to about 30 wt. %, and wherein the silica gel has an open pore volume that is between about 0.2 mL/g to about 1.0 mL/g;
wherein the polymeric binder is present in the liquid coating composition in an amount from about 5 wt. % to about 25 wt. %;
wherein one or more pigments are present in the liquid coating composition in an amount from about 5 wt. % to about 30 wt. %;
wherein the liquid coating composition has a Stormer viscosity in the range from about 80 KU to about 120 KU; and
wherein the silica gel comprises a plurality of particles having an average particle size from about 1 micrometer to about 20 micrometers, each particle having a specific surface area from about 400 m²/g to about 900 m²/g.

111. The method of claim 110, further comprising, prior to adding the one or more pH modifiers to the third mixture, adding one or more additional rheology modifiers to the third mixture, the one of more rheology modifier components comprises a hydroxy ethyl cellulose;

112. The method of claim 110, further comprising, after adding the one or more rheology modifiers, adding one or more pH modifiers to the third mixture to adjust the pH of the third mixture.

113. The method of claim 110, wherein the liquid coating composition has a volatile organic compounds content of below 50 g/L.
